(19) United States
(12) Patent Application Publication
(10) Pub. No.: US 2025/0269541 A1
(43) Pub. Date: Aug. 28, 2025

(54) INPUT UNIT, INPUT DEVICE, AND SYSTEM

(71) Applicant: MELTIN Inc., Tokyo (JP)

(72) Inventors: Masahiro KASUYA, Tokyo (JP); Hokuto AIZAWA, Tokyo (JP)

(73) Assignee: MELTIN Inc., Tokyo (JP)

(21) Appl. No.: 18/858,697

(22) PCT Filed: Apr. 27, 2023
(86) PCT No.: PCT/JP2023/016720

§ 371 Date: Oct. 21, 2024

(30) Foreign Application Priority Data
Apr. 28, 2022 (JP) 2022-075305

(51) Int. Cl. B25J 13/08; B25J 9/16

(52) U.S. Cl. CPC B25J 13/085; B25J 9/1689

(57) ABSTRACT

The disclosure includes an input unit for robot operation having a base, a contact part which is rotatable with respect to the base and with which an operator's finger makes contact. A detection unit can detect the amount of rotation of the contact part with respect to the base. The contact part is configured to: rotate in a first direction about a first axis with respect to the base and in response to flexion of the finger; rotate in a second direction about the first axis with respect to the base in response to an extension motion of the finger; rotate in a third direction about a second axis with respect to the base in response to adduction of the finger; and rotate in a fourth direction about the second axis with respect to the base in response to abduction of the finger.

### CLAIM OF PRIORITY UNDER 35 U.S.C. 119

The present Application for Patent is a national stage filing based on PCT Application No. PCT/JP2023/016720, entitled “INPUT UNIT, INPUT DEVICE, AND SYSTEM” and filed on Apr. 27, 2023, which claims priority to Japanese Patent Application No. 2022-075305 entitled “INPUT UNIT, INPUT DEVICE, AND SYSTEM” filed Apr. 28, 2022, both of which are assigned to the assignee hereof and hereby expressly incorporated by reference herein.

### FIELD OF THE DISCLOSURE

The present invention relates to an input unit for inputting information on a motion of a finger, an input device including a plurality of the input units corresponding to five fingers, a system for performing robot operation by using the input device, and a system for inputting information on a motion of an upper limb including the input device.

### DESCRIPTION OF RELATED ART

Conventionally, an input device that detects a motion of an operator's finger or the like for robot operation such as causing an articulated robot, for example, a robot hand to perform a motion of an operator's finger has been used.

For example, JP-A-4-210390 discloses, as an example of such an input device, a glove in which an optical fiber for detecting bending of a finger is provided.

However, the glove disclosed in JP-A-4-210390 detects the degree of bending of a finger by bending of an optical fiber accompanying bending of the finger wearing the glove, and detects bending and extending motions of a finger when a hand is opened and closed.

### SUMMARY OF THE DISCLOSURE

An object of the present invention is to obtain an input unit capable of detecting not only bending and extending motions of a finger of an operator but also a motion of a finger including adduction and abduction motions of the finger, and an input device including a plurality of such input units corresponding to five fingers.

Further, an object of the present invention is to obtain a system for performing robot operation using the input device of the present invention described above, and further to obtain a system including the input device of the present invention as a system for detecting information on a motion of an upper limb of an operator.

The present invention provides items below.

### Item 1

An input unit for robot operation, the input unit including:
a base portion;
a contact portion provided to be able to swivel with respect to the base portion and in contact with a finger of an operator; and
a detection unit that detects a swivel amount of the contact portion with respect to the base portion, in which
the contact portion is configured to:
swivel in a first direction about a first axis with respect to the base portion according to a bending motion of the finger;
swivel in a second direction about the first axis with respect to the base portion according to an extending motion of the finger;
swivel in a third direction about a second axis with respect to the base portion according to an adduction motion of the finger; and
swivel in a fourth direction about the second axis with respect to the base portion according to an abduction motion of the finger, and
the detection unit is configured to detect a swivel amount about the first axis of the contact portion, a swivel amount about the second axis of the contact portion, and a position of a fingertip of the finger on the contact portion.

### Item 2

The input unit according to Item 1, further including a drive unit that generates reaction force for swiveling the contact portion about the axis.

### Item 3

The input unit according to Item 2, in which the drive unit is a second drive unit that generates second reaction force that swivels the contact portion about the second axis.

### Item 4

The input unit according to Item 3, further including a second force detection unit for detecting the second reaction force, in which the second drive unit is controlled based on the second reaction force detected by the second force detection unit.

### Item 5

The input unit according to Item 4, in which the second force detection unit includes a strain gauge.

### Item 6

The input unit according to Item 4, in which the second force detection unit includes an elastic body connected to the second drive unit and the contact portion.

### Item 7

The input unit according to Item 2, further including an elastic body connected to the drive unit and the contact portion, in which the elastic body is disposed about the axis so as to extend or contract according to the drive unit driving the contact portion to swivel in one direction about the axis.

### Item 8

The input unit according to Item 2, further including an elastic body connected to the drive unit and the contact portion, in which the elastic body includes a first elastic member and a second elastic member, and the first elastic member and the second elastic member are disposed about the axis such that the first elastic member extends and the second elastic member contracts according to the drive unit driving the contact portion to swivel in one direction about the axis.

### Item 9

The input unit according to Item 1, further including a swivel stop mechanism that stops swivel of the contact portion.

### Item 10

The input unit according to Item 9, wherein
the swivel stop mechanism includes:
a rigid rotation member configured to be rotated about the axis by the drive unit; and
a rigid stationary member configured to prevent rotation by an angle equal to or more than a threshold of the rigid rotation member, and
the rigid stationary member collides with the rigid rotation member to stop rotation of the contact portion when rotation by an angle equal to or more than the threshold of the rigid rotation member occurs.

### Item 11

The input unit according to Item 2, in which the drive unit is configured to generate both first reaction force for swiveling the contact portion about the first axis and second reaction force for swiveling the contact portion about the second axis.

### Item 12

The input unit according to Item 1, in which
the contact portion includes:
a contact portion main body;
a fingertip holding portion configured to hold a fingertip of the finger; and
a movable body coupled to the fingertip holding portion, and
the movable body is configured to be movable along an extending direction of the contact portion main body in accordance with movement of the fingertip held by the fingertip holding portion.

### Item 13

The input unit according to Item 12, in which the detection unit detects a position of the fingertip by detecting a position of the movable body.

### Item 14

The input unit according to Item 12, in which the fingertip holding portion is configured to hold a fingertip of the finger in a state where the fingertip is fitted.

### Item 15

The input unit according to Item 12, in which the fingertip holding portion includes a cup-shaped housing into which a fingertip of the finger is fitted and a balloon member provided in the cup-shaped housing, and the balloon member is configured to be inflated in the cup-shaped housing.

### Item 16

The input unit according to Item 12, in which the fingertip holding portion and the movable body are coupled by a universal joint.

### Item 17

The input unit according to Item 12, in which the contact portion is configured to further swivel about a third axis with respect to the base portion, and the third axis is an axis along a direction in which the contact portion main body extends.

### Item 18

The input unit of Item 12, in which the finger is a thumb.

### Item 19

An input device for robot operation, the input device including:
four of the input units according to Item 1; and
one of the input unit according to Item 12.

### Item 20

A robot operation system, including:
the input unit according to any one of Items 1 to 18;
an information processing device configured to estimate a posture of a finger of the operator based on a swivel amount of the contact portion detected by the input unit and a position of the fingertip on the contact portion; and
a robot configured to be operated based on the estimated posture of the finger of the operator, in which
a swivel amount of the contact portion detected by the input unit includes:
a swivel amount about the first axis of the contact portion; and
a swivel amount about the second axis of the contact portion.

### Item 21

A system as a system for inputting a motion of an upper limb of an operator, the system including:
the input unit according to any one of Items 1 to 18; and
an arm motion input device for inputting a motion of an arm of the operator.

### Item 22

The system according to Item 21, in which
the arm motion input device includes:
a first joint connected to the input unit;
a second joint fixedly disposed at a place different from a body of the operator; and
a third joint connecting a first arm extending from the first joint and a second arm extending from the second joint, and
a posture change of the first arm with respect to the input unit, a posture change of the second arm with respect to the first arm, and a posture change of the second joint with respect to the place are output as information indicating a motion of the upper limb.

### Item 23

The system according to Item 21, in which
the arm motion input device includes:
a force sensor that detects force applied to the input device; and
calculating means for integrating force applied to the input device, the force being detected by the force sensor, and
an integral value of force applied to the input device is output as information indicating a motion of the upper limb.

According to the present invention, an input unit capable of detecting not only bending and extending motions of a finger of an operator but also a motion of a finger including adduction and abduction motions of the finger, and an input device including a plurality of such input units corresponding to five fingers can be obtained.

Further, according to the present invention, a system for performing robot operation using the input device of the present invention described above, and further a system including the input device of the present invention as a system for detecting information on a motion of an upper limb of an operator can be obtained.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 is a schematic diagram illustrating a basic configuration of an input unit 100 of the present invention.

FIG. 2 is a plan view illustrating a motion of a contact portion 102 according to a bending motion and an abduction motion of a finger of an operator in the input unit 100 illustrated in FIG. 1, and illustrates a structure of the input unit 100 illustrated in FIG. 1 as viewed from an X direction and a Z direction illustrated in FIG. 1.

FIG. 3 is a block diagram illustrating a basic constituent element of the input unit 100 of the present invention.

FIG. 4 is a conceptual diagram illustrating a mechanism (reaction force generation mechanism) that generates reaction force for haptic presentation in the input unit 100 of the present invention.

FIG. 5 is a schematic diagram illustrating an example of a specific configuration of the reaction force generation mechanism illustrated in FIG. 4.

FIG. 6 is a schematic diagram illustrating another example of the specific configuration of the reaction force generation mechanism illustrated in FIG. 4.

FIG. 7 is a schematic diagram illustrating a rotation stop mechanism of a contact portion in the input unit 100 of the present invention.

FIG. 8 is a schematic diagram illustrating an input unit 100a of a first embodiment of the present invention.

FIG. 9 is a diagram illustrating a motion of the contact portion 102 according to a bending motion of an operator's finger in the input unit 100a illustrated in FIG. 8.

FIG. 10 is a diagram illustrating a motion of the contact portion 102 according to an adduction motion of an operator's finger in the input unit 100a illustrated in FIG. 8.

FIG. 10A is a diagram illustrating an alternative configuration example of a swivel portion in the input unit 100a in FIG. 8.

FIG. 11 is a schematic diagram illustrating a basic configuration of a thumb input unit 200 corresponding to a thumb as a basic configuration of an input unit of the present invention.

FIG. 12 is a plan view illustrating a motion of a contact portion 202 according to a bending motion of a thumb of an operator in the thumb input unit 200 illustrated in FIG. 11, and the thumb input unit 200 illustrated in FIG. 11 is viewed from the X direction in FIG. 11(b).

FIG. 13 is a plan view illustrating a motion of the contact portion 202 according to an adduction motion of a thumb of an operator in the thumb input unit 200 illustrated in FIG. 11, and the thumb input unit 200 illustrated in FIG. 11 is viewed from the Z direction in FIG. 11(b).

FIG. 14 is a plan view illustrating a motion of the contact portion 202 according to a twisting motion to the inner side of a thumb of an operator in the thumb input unit 200 illustrated in FIG. 11, and the thumb input unit 200 illustrated in FIG. 11 is viewed from a Y direction in FIG. 11(b).

FIG. 15 is a block diagram illustrating a basic constituent element of the thumb input unit 200 of the present invention.

FIG. 16 is a schematic diagram illustrating a thumb input unit 200a of a second embodiment of the present invention.

FIG. 16A is a diagram illustrating another configuration example (thumb holder 302c) of a thumb holder 202c in the thumb input unit 200a illustrated in FIG. 16.

FIG. 17 is a diagram illustrating an input device 10 including the thumb input unit 200 illustrated in FIG. 11 and the input unit 100 illustrated in FIG. 1 corresponding to four fingers other than a thumb.

FIG. 18 is a conceptual diagram of a system 1000 for causing a robot 1200 to perform a motion of a finger as a robot operation system including the input device 10 illustrated in FIG. 17.

FIG. 19 is a diagram illustrating a system 2000 for detecting a motion of an upper limb of an operator and inputting the motion to another system as a system including the input device 10 illustrated in FIG. 17.

### DETAILED DESCRIPTION

Hereinafter, the present invention will be described. It is to be understood that terms used herein are used in the sense commonly used in the art unless otherwise noted. Therefore, unless defined otherwise, all technical and scientific terms used herein have the same meaning as commonly understood by a person skilled in the art to which the present invention belongs. In case of conflict, the present description (including definitions) will control.

In the present description, “operator” means a person who provides information for operating a robot by an input unit or an input device of the present invention.

In the present description, when focusing on two parts in the input unit (or members constituting the input unit) of the present invention, “distal” refers to one which is located farther away from a trunk of a human body between the two parts, and “proximal” refers to one which is located closer to a trunk of a human body between the two parts.

As used herein, “about” means within ±10% of a number that follows.

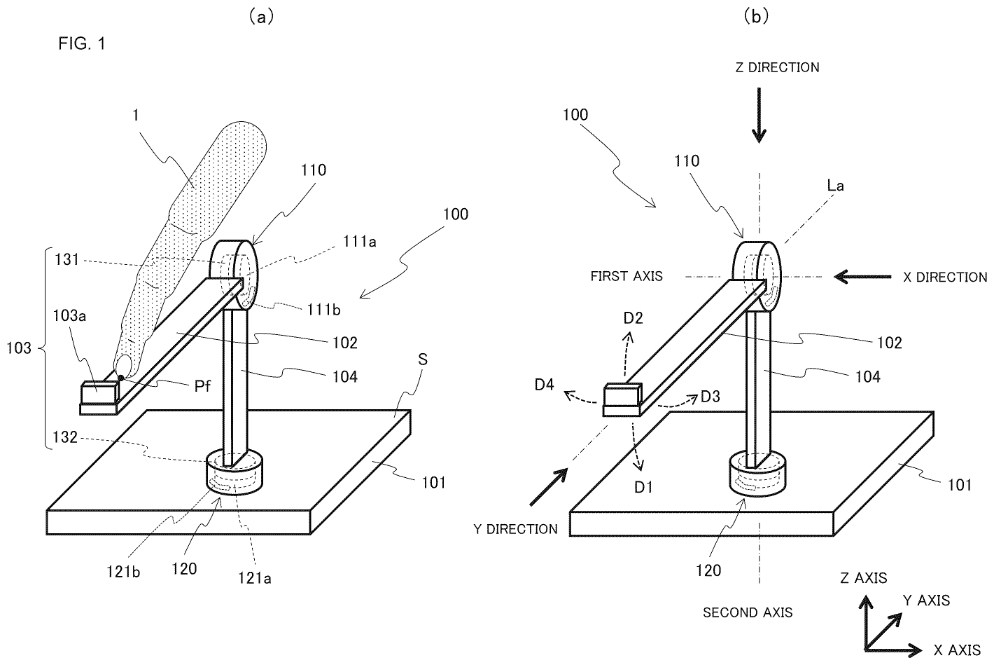

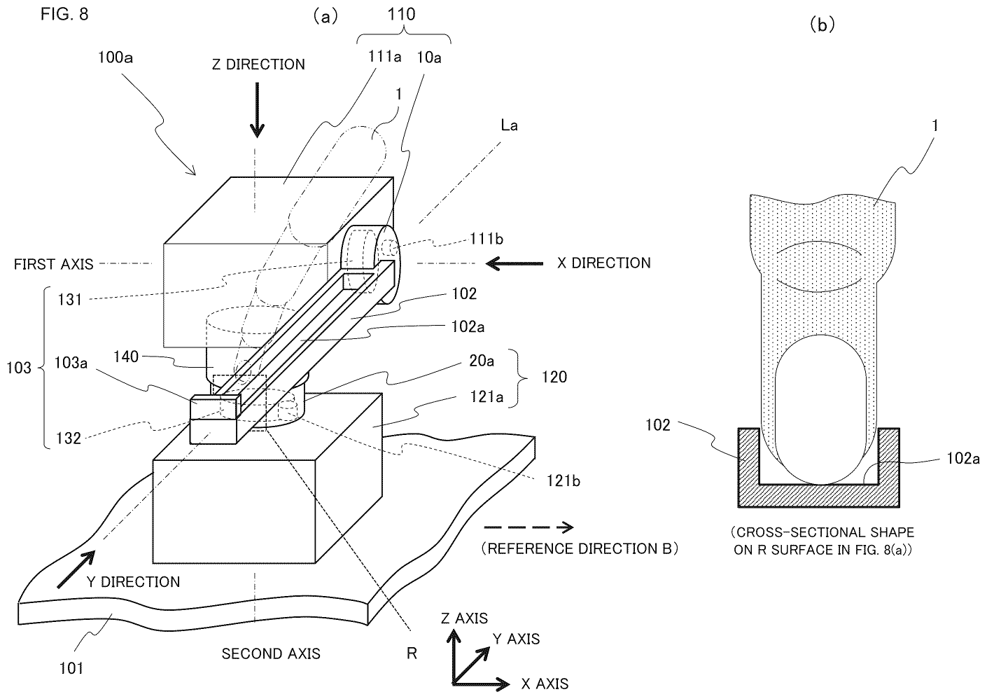

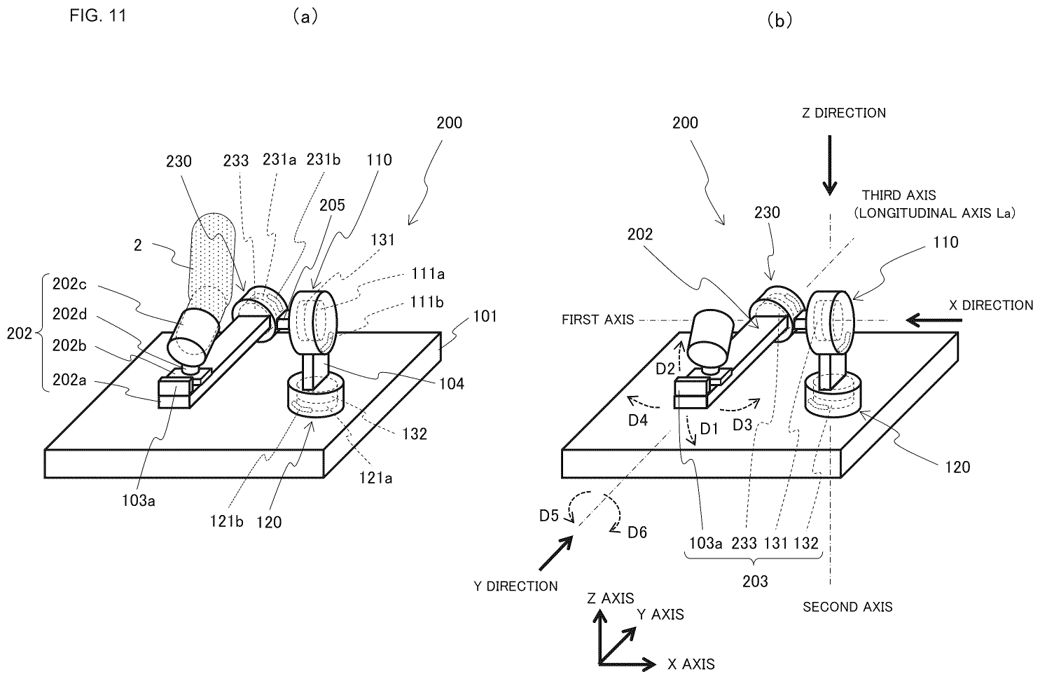

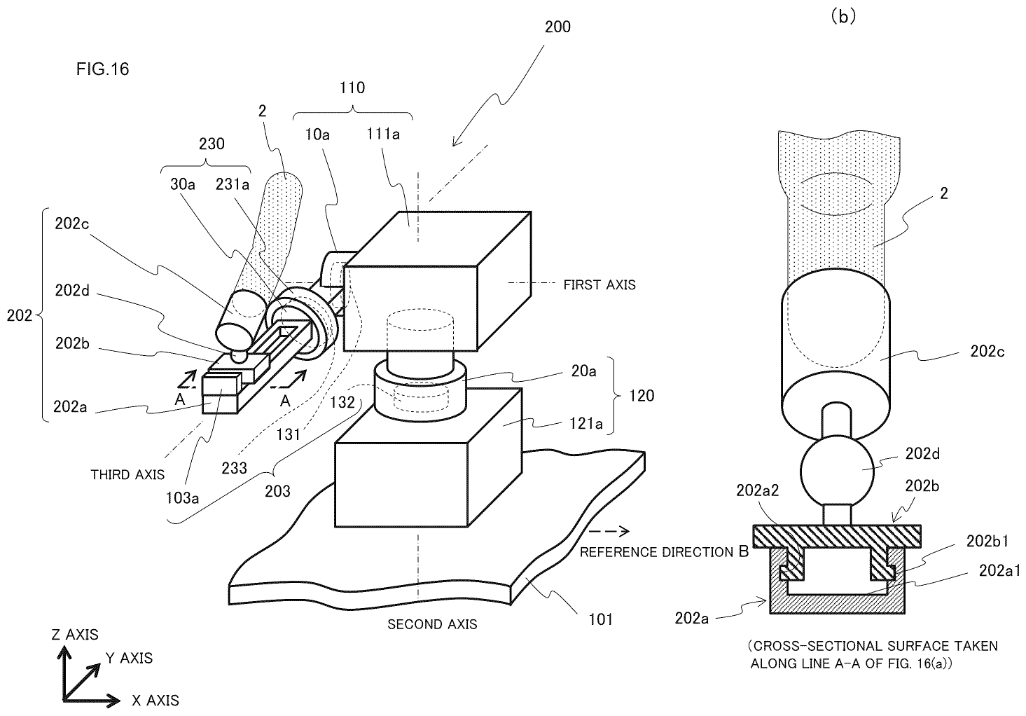

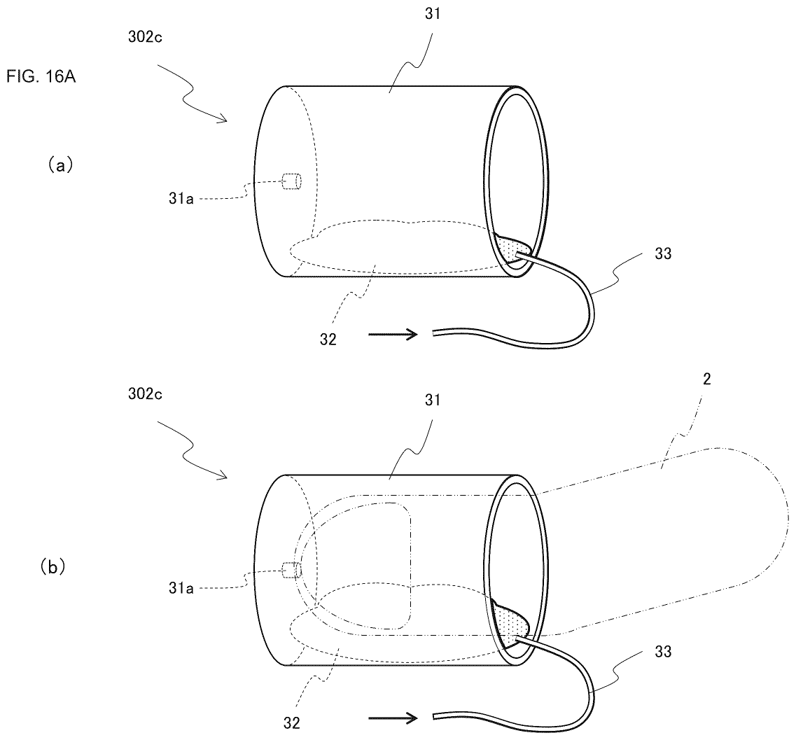

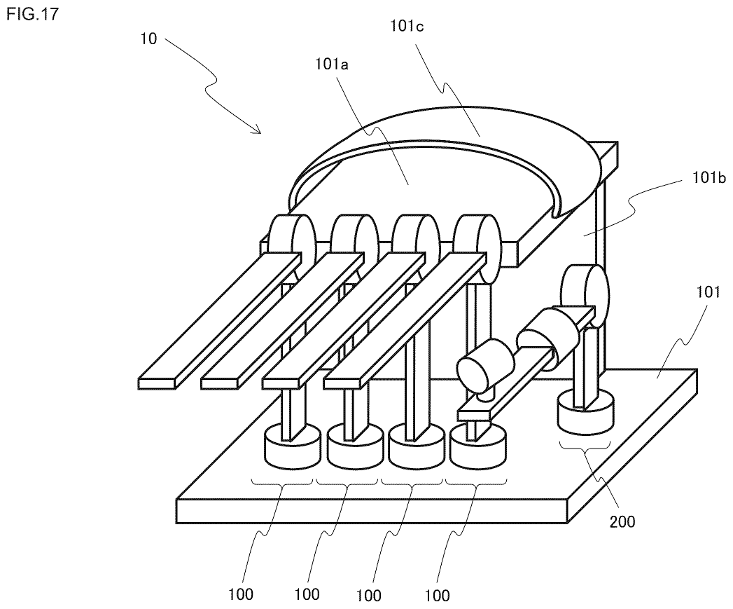

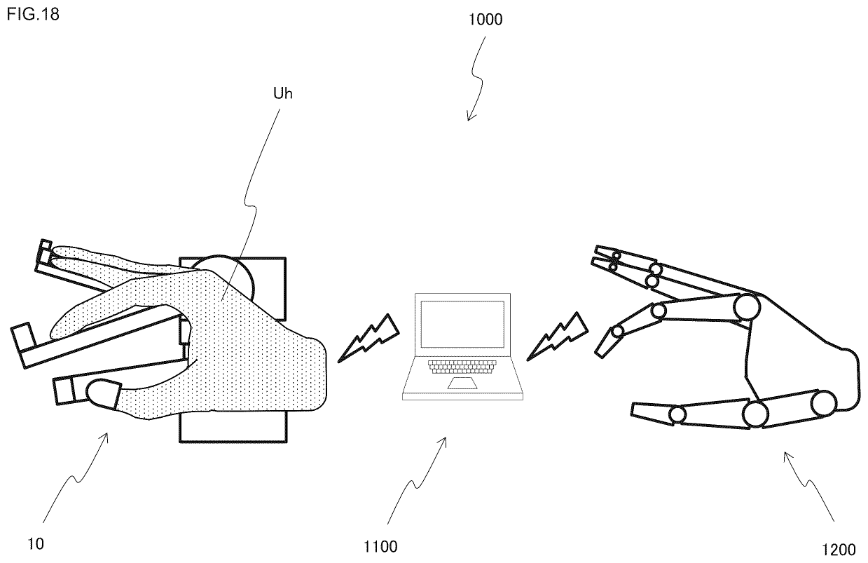

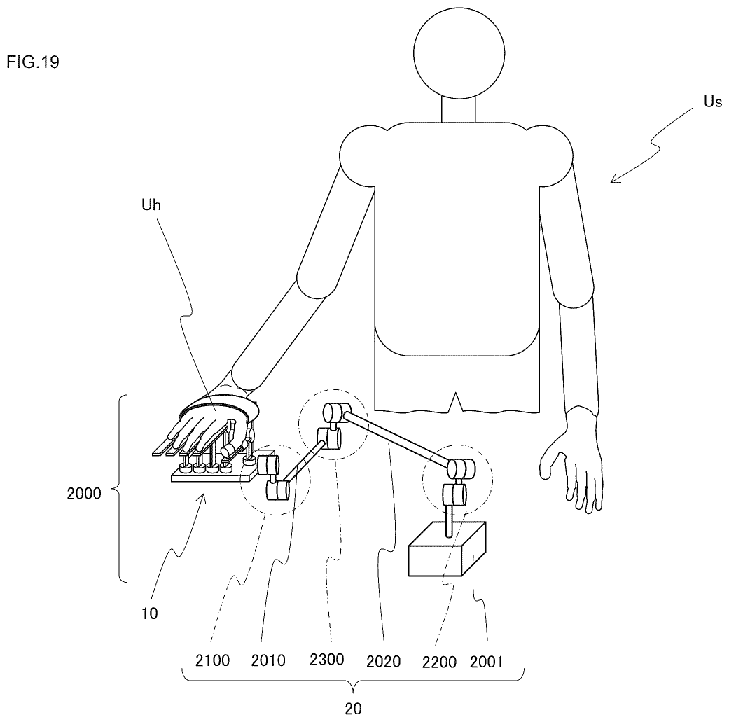

Further, in the present description, the present invention will be described by being divided into Items [1] to [5] below.
[1] An input unit 100 of the present invention (see FIGS. 1 to 7) and an input unit 100a of a first embodiment (see FIGS. 8 to 10 and FIG. 10A) will be described.
[2] A thumb input unit 200 of the present invention (see FIGS. 11 to 15) and a thumb input unit 200a of a second embodiment (see FIG. 16 and FIG. 16A) will be described. Here, the thumb input unit is an input unit suitable for detecting motion information of a thumb.
[3] An input device 10 (see FIG. 17) including the input units 100 and 200 corresponding to five fingers will be described.
[4] A system (see FIG. 18) including the input device 10 illustrated in FIG. 17 will be described as a system (robot operation system) that causes a robot to perform a motion of a finger of an operator.
[5] A system (see FIG. 19) including the input device 10 illustrated in FIG. 17 will be described as a system (upper limb motion detection system) that detects a motion of a movable part such as an upper limb of a human body.

Hereinafter, the present invention will be described in the above order.
[1] The input unit 100 will be described.

FIG. 1 is a schematic diagram illustrating a basic configuration of the input unit 100 of the present invention. FIG. 1(a) illustrates a state where a finger 1 is disposed on the input unit 100, and FIG. 1(b) illustrates swiveling directions D1 to D4 of a contact portion 102 accompanying a motion of the finger 1.

The input unit 100 of the present invention detects a motion of the finger 1 of an operator and transmits the motion to another device or system, and here, information on the motion of the finger 1 detected by the input unit 100 is used for robot operation. Here, the robot operation is not limited to robot operation in a real world, and includes robot operation in a virtual space (metaverse) accessed using VR “Virtual Reality” (a technique that allows experience of a virtual world). Furthermore, information on a motion of the finger 1 detected by the input unit 100 is used not only for robot operation in metaverse but also for operation of an avatar in metaverse, and is further used for operation of an operation target in another simulated environment, for example, an augmented reality world accessed using AR “Augmented Reality” (a technique that allows experience of a virtual world superimposed on the real world) or a mixed reality world realized using MR “Mixed Reality” (a technique that integrates the real world with a virtual world (VR)).

As described above, information on a motion of the finger 1 detected by the input unit 100 of the present invention may be used to operate an object as an operation target in xR “Cross Reality”, that is, a world created by a technique that makes it possible to perceive things that are not real by integrating the real world with a virtual world.

Note that, hereinafter, in description of the input unit 100, the finger 1 is assumed to be the index finger of the right hand. However, the finger 1 may be a finger other than the index finger of the right hand or a finger of the left hand.

As illustrated in FIG. 1(a), the input unit 100 includes a base portion 101, a contact portion 102 with which the finger 1 of an operator comes into contact, and a detection unit 103 that detects a swivel amount of the contact portion 102 with respect to the base portion 101.

### Base Portion 101

The base portion 101 is a base portion of the input unit 100, and other configurations are not limited and may be optional as long as the base portion 101 is a base portion for attaching the contact portion 102 and the detection unit 103 to a surface of the base portion 101. For example, the base portion 101 may be a plate or a block serving as a base portion of the input unit 100, and a material of the base portion 101 is not limited, and is resin, metal, wood, ceramic, or the like. However, in description below, in the input unit 100, a surface of the base portion 101 is assumed to be configured to be parallel to a base surface on which an input unit is installed.

### Contact Portion 102

As illustrated in FIG. 1(b), the contact portion 102 is provided to be able to swivel in the first to fourth directions D1 to D4 with respect to the base portion 101. A specific structure of the contact portion 102 is not limited, but for example, an elongated plate-like member or an elongated rod-like member can be used. Further, the material is also not limited, and resin, metal, wood, ceramic, or the like can be used.

Here, the contact portion 102 is configured to swivel in the first direction D1 about a first axis with respect to the base portion 101 in accordance with a bending motion of the finger 1, swivel in the second direction D2 about the first axis with respect to the base portion 101 in accordance with an extending motion of the finger 1, swivel in the third direction D3 about a second axis with respect to the base portion 101 in accordance with an adduction motion of the finger 1, and swivel in the fourth direction D4 about the second axis with respect to the base portion 101 in accordance with an abduction motion of the finger 1.

Therefore, the input unit 100 substantially includes at least a first swivel portion 110 that supports the contact portion 102 so as to be able to swivel about the first axis with respect to the base portion 101 and a second swivel portion 120 that supports the contact portion 102 so as to be able to swivel about the second axis with respect to the base portion 101. The first swivel portion 110 and the second swivel portion 120 are connected via a coupling portion 104 which is another member, the second swivel portion 120 supports the first swivel portion 110 to be able to swivel about the second axis with respect to the base portion 101, and the first swivel portion 110 supports the contact portion 102 to be able to swivel about the first axis with respect to the base portion 101. Note that the first swivel portion 110 and the second swivel portion 120 may be directly connected without interposing another member.

Here, specific configurations of the first swivel portion 110 and the second swivel portion 120 are not limited and may be optional.

For example, the input unit 100 may include one swivel portion capable of swiveling the contact portion 102 about the first axis and about the second axis instead of including two swivel portions of the first swivel portion 110 that swivels the contact portion 102 about the first axis with respect to the base portion 101 and the second swivel portion 120 that swivels the contact portion 102 about the second axis with respect to the base portion 101.

Note that description below regarding swivel of the contact portion 102, three-dimensional coordinates will be used to clarify a direction of an axis (swivel axis) when the contact portion 102 swivels. As illustrated in FIG. 1, an X axis is defined as an axis parallel to a width direction of a palm in an initial posture of an input unit, a Z axis is defined as an axis parallel to a normal direction of a palm in the initial posture of the input unit, and a Y axis is defined as an axis orthogonal to the Z axis and the X axis in the initial posture of the input unit. Here, the initial posture refers to a state in which at least a fingertip of the finger 1 of an operator is substantially placed on the contact portion 102 of the input unit 100, and a longitudinal axis of the contact portion 102 is held in a posture parallel to a surface of the base portion 101 and perpendicular to a width direction of a palm. Further, in the input unit 100, there is a standby state in which a fingertip of the finger 1 of an operator is not placed on the contact portion 102 of the input unit 100, separately from the initial posture. There is a case where of hyperextension of a finger (case where a finger is bend backward) as a motion of a finger of a person, and also in this case, a contact portion follows a motion of the finger. For this reason, in the input unit 100, a posture of the contact portion 102 is inclined such that a tip of the contact portion 102 faces obliquely upward with respect to a surface of a base portion in the standby state.

Therefore, in the input unit 100, the contact portion 102 is biased by elastic force of a spring or torque of a motor so that the contact portion 102 does not hang down by its own weight in the standby state or the initial posture.

Then, in the input unit 100, in the initial posture, the first axis (axis when the contact portion 102 swivels according to bending and extending motions of a finger) is parallel to the X axis, the second axis (axis when the contact portion 102 swivels according to the adduction and abduction motions of a finger) is parallel to the Z axis, and an axis (longitudinal axis) La in a longitudinal direction of the contact portion 102 is parallel to the Y axis.

However, when transition is made from the initial posture to a motion state (adduction and abduction state) in which the contact portion 102 swivels about the second axis, the first swivel portion itself swivels about the second axis, so that the first axis becomes an axis inclined with respect to the X axis. However, even when transition is made from the initial posture to the motion state (adduction and abduction state), the second swivel portion itself does not swivel with respect to the base portion, and thus the state in which the second axis is parallel to the Z axis is maintained.

Further, when transition is made from the initial posture to a motion state (bending and extending state) in which the contact portion 102 swivels about the first axis, the longitudinal axis La of the contact portion 102 becomes an axis inclined with respect to the Y axis. However, even when transition is made from the initial posture to the motion state (bending and extending state), neither the first swivel portion itself nor the second swivel portion itself swivels with respect to the base portion. Therefore, a state in which the first axis is parallel to the X axis and the second axis is parallel to the Z axis is maintained.

That is, swivel of the contact portion accompanying bending and stretching of a finger from the initial posture is performed about the X axis since the first axis is parallel to the X axis in the initial posture, and swivel of the contact portion accompanying adduction and abduction of a finger from the initial posture is performed about the Z axis since the second axis is parallel to the Z axis in the initial posture.

On the other hand, in a case where the contact portion 102 swivels about the first axis along with bending and stretching of a finger from the initial posture and then the contact portion swivels about the second axis along with adduction and abduction of the finger, the second axis is parallel to the Z axis in this state, and the contact portion swivels about the Z axis. However, in a case where the contact portion 102 swivels about the second axis along with adduction and abduction of a finger from the initial posture and then the contact portion swivels about the first axis along with bending and stretching of the finger from the initial posture, the first axis is not parallel to the X axis in this state, and the contact portion swivels about the first axis inclined with respect to the X axis in an XY plane instead of the X axis.

### Detection Unit 103

The detection unit 103 is configured to detect a swivel amount around the first axis of the contact portion 102, a swivel amount around the second axis of the contact portion 102, and a position Pf of a fingertip of the finger 1 on the contact portion 102.

That is, other configurations of the detection unit 103 are not limited and may be optional as long as the detection unit 103 substantially includes a position detection unit 103a that detects the position Pf of a fingertip of the finger 1 on the contact portion 102, a first swivel amount detection unit 131 that detects a swivel amount about the first axis of the contact portion 102, and a second swivel amount detection unit 132 that detects a swivel amount about the second axis of the contact portion 102.

For example, the position detection unit 103a may be provided on the distal end side of the contact portion 102 or may be provided on the proximal end side of the contact portion 102. In particular, in a case where a sensor such as a capacitance sensor or an optical sensor is used as the position detection unit 103a, the position detection unit 103a may include a configuration in which a plurality of capacitance sensors or a plurality of optical sensors are arranged on the contact portion 102 along a longitudinal direction of the contact portion 102. Further, the first swivel amount detection unit 131 may be incorporated in the first swivel portion 110 or may be provided outside the first swivel portion 110. Similarly, the second swivel amount detection unit 132 may be incorporated in the second swivel portion 120 or may be provided outside the second swivel portion 120. A magnetic encoder or an optical encoder may be used for these swivel amount detection units.

The input unit 100 of the present invention having such a configuration can detect motions of the finger 1 including not only bending and extending motions of the finger 1 of an operator but also adduction and abduction motions of the finger 1. Hereinafter, a function of detecting such a motion of the finger 1 will be described.

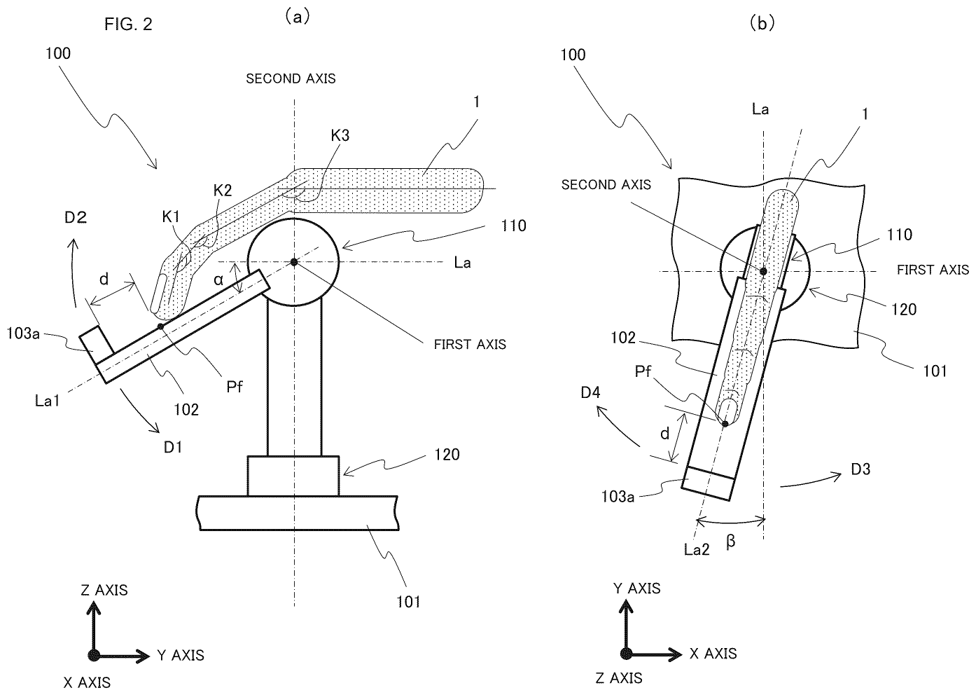

FIG. 2 is a plan view for explaining a motion of the contact portion of the input unit 100 illustrated in FIG. 1. FIG. 2(a) illustrates a structure of the input unit 100 illustrated in FIG. 1(a) as viewed from an X direction (direction parallel to the X axis) in FIG. 1(b). FIG. 2(b) illustrates a structure of the input unit 100 illustrated in FIG. 1(a) as viewed from a Z direction (direction parallel to the Z axis) in FIG. 1(b).

For example, as illustrated in FIG. 2(a), in a case where the finger 1 is bent and a change is made from a state in which the finger 1 is parallel to a surface of a palm to a state in which the finger 1 is inclined with respect to the surface of the palm, the longitudinal axis La of the contact portion 102 is swiveled from a state of being parallel to the Y axis to a state of forming an angle α with respect to the Y axis by swivel of the contact portion 102 about the first axis to become a longitudinal axis La1.

In this case, the first swivel amount detection unit 131 detects the angle α, and the position detection unit 103a detects the position Pf of the finger 1 on the contact portion 102 as a distance d from the position detection unit 103a to the finger 1, so that first to third joint angles K1 to K3 of the finger 1 can be obtained based on inverse kinematics from these detection values. However, a first joint (DIP joint) and a second joint (PIP joint) are assumed to bend in conjunction at the equal joint angle (K1=K2).

Note that as the contact portion 102 is configured to be able to swivel in accordance with extension of the finger 1, the first to third joint angles K1 to K3 of the finger 1 can be obtained in the same manner as in the case where the finger 1 is bent also in a case where the finger 1 is extended (including a case of hyperextension in which the finger is bent backward).

Further, in a case where the finger 1 is assumed to be the index finger of a right hand, when the finger 1 is abducted as illustrated in FIG. 2(b) (in a case where the finger 1 is assumed to be the index finger of a left hand, when the finger 1 is adducted), the longitudinal axis La of the contact portion 102 swivels from a state of being parallel to the Y axis to a state of forming an angle β with respect to the Y axis by swivel about the second axis of the contact portion 102 and becomes a longitudinal axis La2.

In this case, the second swivel amount detection unit 132 detects the angle β, so that a second swivel amount (swivel amount about the second axis) of the contact portion 102 can be detected.

Note that also in a case where an index finger 1a of a right hand is adducted, the second swivel amount of the contact portion 102 can be detected similarly to a case where the index finger 1a is abducted.

Therefore, the input unit of the present invention includes the base portion 101, the contact portion 102 with which a finger of an operator comes into contact, and the detection unit 103 that detects a swivel amount of the contact portion with respect to the base portion, and other configurations are not particularly limited and may be optional as long as the detection unit detects a swivel amount of the contact portion with respect to the base portion according to a bending motion, an extending motion, an adduction motion, and an abduction motion of a finger and simultaneously detects the position Pf of a fingertip of the finger on the contact portion.

That is, by having such a configuration, the input unit of the present invention can estimate a posture of a finger based on inverse kinematics from a swivel amount of the contact portion 102 with respect to the base portion 101 detected by the detection unit 103 and a position of a fingertip of the finger 1 on the contact portion 102, and as a result, a motion of a part including multiple joints such as a finger of an operator can be detected from swivel information of the part and position information of the finger of the operator.

In this case, it is not necessary to provide a configuration for detecting a joint angle for each joint, and it is also easy to add a configuration for an additional function such as haptics for presenting a force sense to an operator (that is, a function of providing an operator with a feel when a finger of a robot touches an object).

That is, the input unit of the present invention has a haptic function by including a drive unit that generates reaction force for swiveling the contact portion 102 about either the first axis or the second axis.

The drive unit may be incorporated in a corresponding swivel portion or may be provided outside a corresponding swivel portion.

Further, the input unit of the present invention may include only a drive unit that generates reaction force for swiveling the contact portion 102 about one of the first axis and the second axis described above, or may include one drive unit that generates reaction force for swiveling the contact portion 102 about the first axis and another drive unit that generates reaction force for swiveling the contact portion about the second axis. Furthermore, these drive units may present a vibration sense or texture by switching reaction force to be generated at high speed. Further, by arranging a belt driven by a drive unit on the contact portion 102, reaction force in the longitudinal direction of the contact portion 102 may be generated to present a force sense by which a finger is pulled, or pressed conversely.

Hereinafter, the input unit 100 of the present invention will be conceptually further described.

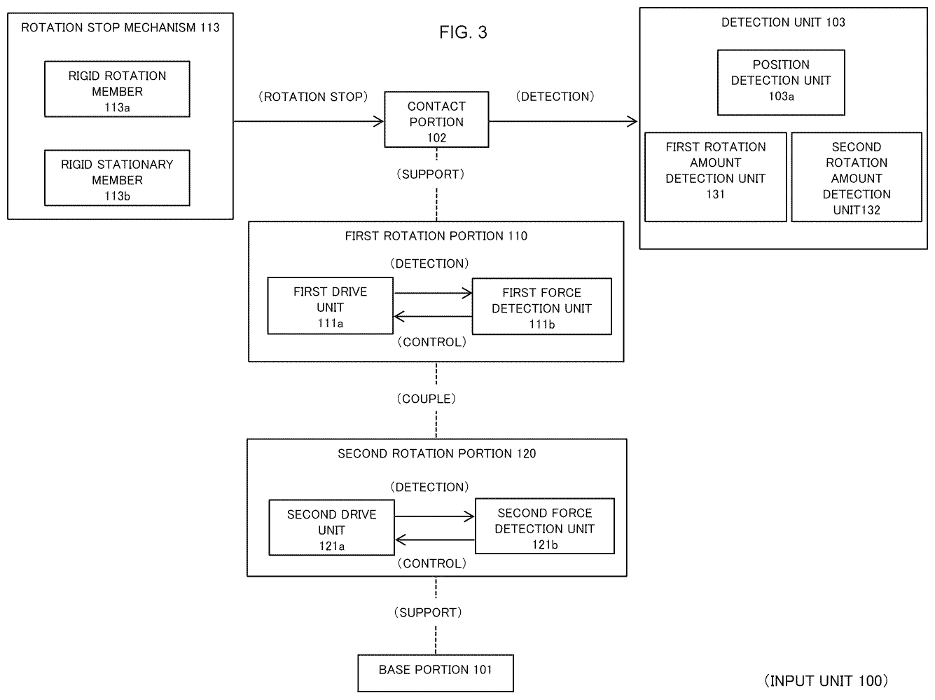

FIG. 3 is a block diagram illustrating a basic constituent element of the input unit 100 of the present invention.

### Drive Unit

For example, as illustrated in FIGS. 1 and 3, the input unit 100 preferably includes a drive unit (second drive unit) 121a that generates reaction force (second reaction force) in adduction and abduction directions for swiveling the contact portion about the second axis. Note that the second drive unit 121a may be incorporated in the second swivel portion 120 or may be provided outside the second swivel portion 120.

In this case, by a function (haptic function) of generating the second reaction force with respect to adduction and abduction motions of a finger by an operator (that is, a motion in which an operator moves a finger left and right along a plane substantially parallel to a palm) and transmitting a force sense to the finger of the operator, the operator can sense a feel of a robot being remotely operated gripping an object by adduction and abduction of a finger. However, such a haptic function is not necessarily required, and the input unit 100 does not need to include the drive unit (second drive unit) 121a that generates the second reaction force for swiveling the contact portion about the second axis.

Similarly, as illustrated in FIGS. 1 and 3, the input unit 100 preferably further includes a drive unit (first drive unit) 111a that generates reaction force (first reaction force) in bending and extending directions for swiveling the contact portion about the first axis. Note that the first drive unit 111a may be incorporated in the first swivel portion 110 or may be provided outside the first swivel portion 110. Note that a motor such as a servo motor can be used for the drive unit.

In this case, by a function (haptic function) of generating the first reaction force with respect to bending and extending motions of a finger by an operator (that is, a motion in which an operator bends and stretches a finger along a plane substantially perpendicular to a palm) and transmitting a force sense to the finger of the operator, the operator can sense a feel of a robot being remotely operated gripping an object by bending (extending in some cases) of a finger. However, such a haptic function is not necessarily required, and the input unit 100 does not need to include the first drive unit 111a that generates the first reaction force for swiveling the contact portion 102 about the first axis.

Furthermore, the first and second reaction forces generated by the first and second drive units 111a and 121a described above vary according to strength with which a robot grips an object, and are preferably feedback-controlled so as to be reaction forces according to force with which the robot grips the object. In that case, control of reaction force is force feedback type bilateral control. As feedback control of such reaction force, there are other bilateral control of a symmetric type, a force reflecting type, an acceleration type, and the like, and such bilateral control may be implemented.

The bilateral control here is a method of simultaneously performing posture control from a master to a slave and force control from the slave to the master by control of matching postures and force states between the input unit (master) 100 and a robot (slave) operated by the input unit 100.

In particular, the symmetric type is a method of controlling both the master and the slave so that there is no relative displacement between them, and the force reflecting type is a method of performing positioning control of the slave based on relative displacement and reproducing force applied to the slave by the master. Further, the force feedback type is different from the force reflecting type in that force in the master is reproduced based on a difference between force in the master and force in the slave. Furthermore, the acceleration type is a method of controlling postures of and generated force in the master and the slave by using acceleration of a posture change and a change in generated force as a control amount.

Note that the bilateral control does not necessarily present reaction force, and some bilateral control does not present reaction force. For example, a force forward feed type is a method in which positioning control of the master is performed based on relative displacement, and force applied to the master is reproduced by the slave. In the force forward feed type, force information is transmitted from the master (input unit) to the slave (robot), position information (that is, angle information of the contact portion) is received by the master, and generation of reaction force (haptic presentation) is not performed.

### Force Detection Unit

Specifically, as illustrated in FIGS. 1 and 3, the input unit 100 may include a force detection unit (second force detection unit) 121b that detects the second reaction force generated by the second drive unit 121a, and the second drive unit 121a may be feedback-controlled such that the second reaction force detected by the second force detection unit 121b becomes reaction force according to information indicating force for gripping an object from a robot. Note that the second force detection unit 121b may be incorporated in the second swivel portion 120 or may be provided outside the second swivel portion 120.

Similarly, as illustrated in FIGS. 1 and 3, the input unit 100 may further include a force detection unit (first force detection unit) 111b that detects the first reaction force generated by the first drive unit 111a, and the first drive unit 111a may be feedback-controlled such that the first reaction force detected by the first force detection unit 111b becomes reaction force according to information indicating a force for gripping an object from a robot. Note that the first force detection unit 111b may be incorporated in the first swivel portion 110 or may be provided outside the first swivel portion 110.

However, in some cases, feedback control of the first and second reaction forces is unnecessary, and the first and second drive units 111a and 121a may always generate constant reaction force.

Furthermore, in one embodiment, the second force detection unit 121b may include a strain gauge as a member for detecting reaction force, or in another embodiment, the second force detection unit 121b may include, as a member for detecting reaction force, an elastic body connected to the second drive unit 121a and the contact portion 102. In any case, the second force detection unit can detect magnitude of reaction force based on an elongation rate at which the strain gauge or the elastic body extends when corresponding reaction force is applied.

Similarly, in one embodiment, the first force detection unit 111b may include a strain gauge as a member for detecting reaction force or in another embodiment, the first force detection unit 111b may include, as a member for detecting reaction force, an elastic body connected to the first drive unit 111a and the contact portion 102.

Further, the drive unit and the contact portion may be connected with an elastic body as a member for generating reaction force interposed between them. In this case, the elastic body is disposed around an axis so as to extend or contract according to the drive unit driving the contact portion to swivel in one direction around the axis.

Further, the elastic body for generating reaction force connected between the drive unit and the contact portion may include a first elastic member and a second elastic member, and the first elastic member and the second elastic member may be arranged around an axis such that the first elastic member extends and the second elastic member contracts according to the drive unit driving the contact portion to swivel in one direction around the axis.

Specifically, in one embodiment, the elastic body (first elastic body) connected to the first drive unit 111a and the contact portion 102 may be disposed about the first axis so as to extend or contract according to the first drive unit 111a driving the contact portion 102 to swivel in the second direction (direction opposite to a direction in which the contact portion swivels when a finger bends) D2.

Alternatively, in another embodiment, the elastic body (first elastic body) connected to the first drive unit 111a and the contact portion 102 may be disposed about the first axis so as to extend or contract according to the first drive unit 111a driving the contact portion 102 to swivel in the first direction (direction opposite to a direction in which the contact portion swivels when a finger extends) D1.

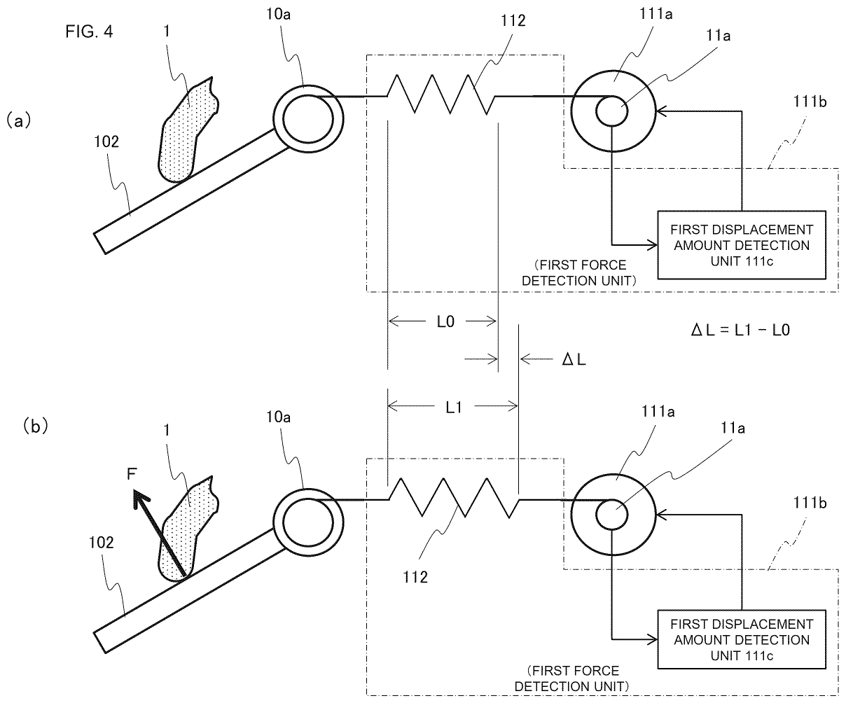

FIG. 4 is a schematic diagram for explaining a reaction force generation mechanism that generates reaction force for haptic presentation in the input unit 100 of the present invention. FIG. 4(a) illustrates a state in which no reaction force is generated, and FIG. 4(b) illustrates a state in which reaction force is generated.

The first force detection unit 111b includes an elastic body 112 connected to the first drive unit 111a and the contact portion 102, and a first displacement amount detection unit 111c that measures a displacement amount of the elastic body, and is configured to control the first drive unit 111a so that torque applied to the contact portion 102 becomes torque corresponding to force sense information acquired from a robot hand.

In the first force detection unit 111b, one end of the first elastic portion 112 is connected to the movable portion 10a that rotates together with the contact portion 102 of the first swivel portion 110, and another end of the first elastic portion 112 is connected to a rotation shaft portion 11a of the first drive unit 111a that swivels the contact portion 102. As rotation of the rotation shaft portion 11a causes the elastic portion 112 to extend, reaction force F is generated at the contact portion 102. Further, in the first force detection unit 111b, magnitude of generated reaction force is calculated from a displacement amount ΔL of the elastic body detected by the first displacement amount detection unit 111c based on Hooke's law. The first force detection unit 111b controls the first drive unit 111a so that magnitude of calculated reaction force becomes magnitude corresponding to force sense information acquired from a robot hand.

Further, arrangement and configuration of an elastic body connected to the second drive unit 121a and the coupling portion 104 are not limited and may be optional, similarly to the elastic body connected to the first drive unit 111a and the contact portion 102.

Specifically, in one embodiment, the elastic body connected to the second drive unit 121a and the coupling portion 104 (or the first swivel portion 110) may be disposed about the second axis (about the Z axis) so as to extend or contract according to the second drive unit 121a swiveling the contact portion 102 in the fourth direction (direction opposite to a direction in which the contact portion swivels when a finger is adducted) D4. Alternatively, in another embodiment, the elastic body connected to the second drive unit 121a and the coupling portion 104 (or the first swivel portion 110) may be disposed about the second axis (about the Z axis) so as to extend or contract according to the second drive unit 121a swiveling the contact portion 102 in the third direction (direction opposite to a direction in which the contact portion swivels when a finger is abducted) D3.

### Specific Configuration of Elastic Body in Reaction Force Generation Mechanism

Note that a reaction force generation mechanism is hereinafter also referred to as a haptic mechanism.

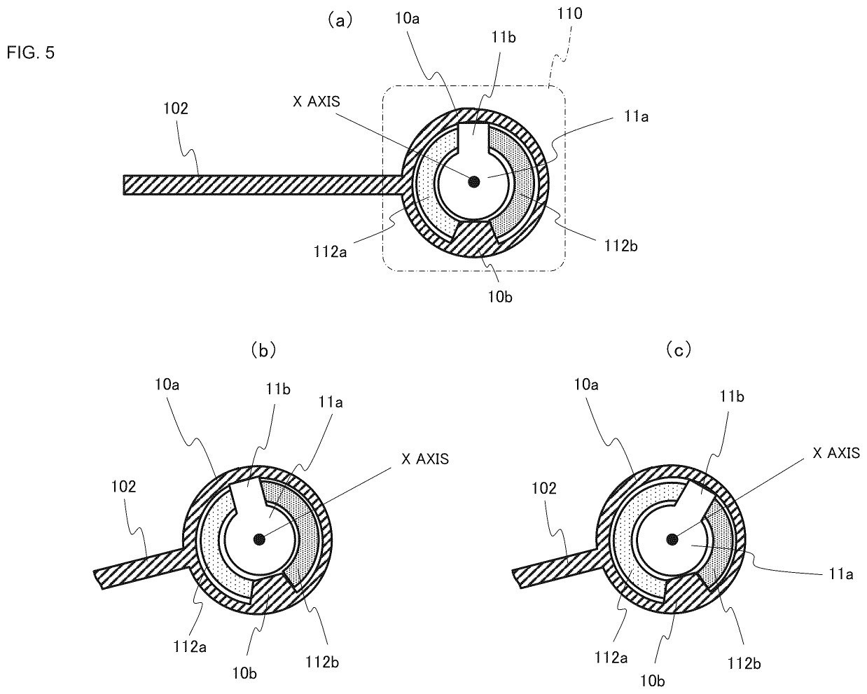

FIG. 5 is a schematic diagram for explaining an example of a specific configuration of the haptic mechanism illustrated in FIG. 4, FIG. 5(a) illustrates a structure of the first swivel portion 110 in which the haptic mechanism is incorporated, FIG. 5(b) illustrates a non-operating state of the haptic mechanism, and FIG. 5(c) illustrates an operating state of the haptic mechanism.

In the first swivel portion 110 including the haptic mechanism illustrated in FIG. 5, as illustrated in FIG. 5(a), the rotation shaft portion 11a of the first drive unit 111a is disposed in the movable portion (movable housing) 10a of the first swivel portion 110, and two elastic members (a first elastic member 112a and a second elastic member 112b) are disposed in series around the rotation shaft portion 11a between the movable housing 10a and the rotation shaft portion 11a. Note that on an inner surface of the movable housing 10a, a housing-side fixing portion 10b for fixing the elastic members 112a and 112b is formed, and on the rotation shaft portion 11a, a shaft-side fixing portion 11b for fixing the elastic members 112a and 112b is formed.

Then, when the rotation shaft portion 11a rotates with respect to the housing 10a from a reference position of the rotation shaft portion 11a with respect to the housing 10a (a position where reaction force is not generated illustrated in FIG. 5(b)), one of two of the elastic members 112a and 112b extends and the other contracts according to a rotation direction, so that torque generated by the rotation of the rotation shaft portion 11a acts as reaction force on the contact portion 102.

For example, as illustrated in FIG. 5(c), when the rotation shaft portion 11a rotates rightward from a rotational position of the rotation shaft portion 11a with respect to the housing 10a illustrated in FIG. 5(a), the first elastic member 112a extends by being pulled by the housing-side fixing portion 10b and the shaft-side fixing portion 11b, and the second elastic member 112b contracts by being compressed by the housing-side fixing portion 10b and the shaft-side fixing portion 11b.

As described above, the elastic body 112 (see FIG. 4) connected to the first drive unit 111a and the contact portion 102 may include, for example, the first elastic member 112a and the second elastic member 112b, and the first elastic member 112a and the second elastic member 112b may be arranged around the first axis such that the first elastic member 112a extends (or contracts) and the second elastic member 112b contracts (or extends) in response to the first drive unit 111a driving the contact portion 102 to swivel in the second direction D2 (or in the first direction D1).

Further, in the second swivel portion 120, an elastic body is connected to a rotation shaft portion (not illustrated) and a movable housing (not illustrated) of the second drive unit 121a. Note that, here, the movable housing is a portion that swivels together with the coupling portion 104 (portion that couples the second swivel portion 120 and the first swivel portion 110) of the second swivel portion 120, and the elastic body includes a first elastic member and a second elastic member.

Also in the second swivel portion 120 having such a configuration, the first elastic member and the second elastic member may be disposed around the second axis such that one of the first elastic member and the second elastic member extends and the other contracts in response to the second drive unit 121a driving the contact portion 102 (directly, the coupling portion 104 between the second swivel portion 120 and the first swivel portion 110) to swivel in the fourth direction D4 (or in the third direction D3).

### Alternative Example of Specific Configuration of Haptic Function

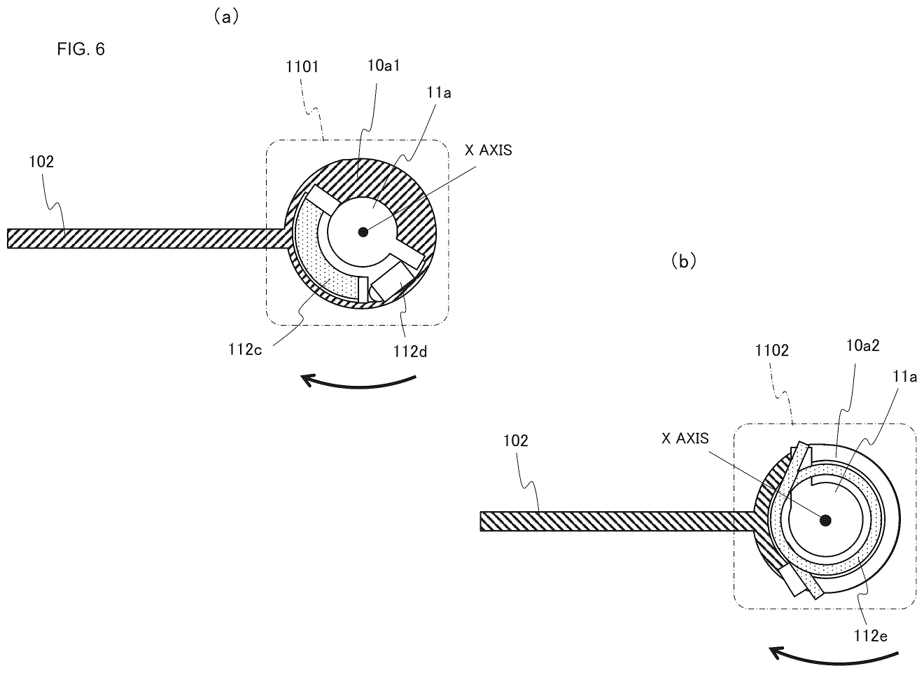

FIG. 6 is a schematic diagram illustrating an alternative example of a specific configuration of the haptic function illustrated in FIG. 5, in which FIG. 6(a) illustrates that a ball plunger 112d and a compression spring 112c are used as one alternative example, and FIG. 6(b) illustrates that a torsion spring 112e is used as another alternative example.

In a first swivel portion 1101 including the haptic mechanism illustrated in FIG. 6(a), the rotation shaft portion 11a of the first drive unit 111a is disposed in a movable housing 10a1 of the first swivel portion 1101, and two elastic members (the compression spring 112c and the spring ball plunger 112d) are disposed in series around the rotation shaft portion 11a between the movable housing 10a1 and the rotation shaft portion 11a. Note that an inter-spring movable piece is disposed between one end of the compression spring 112c and one end of the spring ball plunger 112d, another end of the compression spring 112c is fixed to a housing 10c with a spring fixing tool, and another end of the spring ball plunger 112d abuts on the rotation shaft portion 11a. Note that, here, the spring ball plunger 112d is a spring softer than the compression spring 112c.

In the first swivel portion 1101, when the rotation shaft portion 11a rotates with respect to the movable housing 10a1 from a reference position (that is, a position where no reaction force is generated) of the rotation shaft portion 11a with respect to the movable housing 10a1, reaction force is generated by two elastic members. In this case, resolution in a low-load region of reaction force can be enhanced by an action of the soft spring ball plunger 112d.

In a first swivel portion 1102 including the haptic mechanism illustrated in FIG. 6(b), the rotation shaft portion 11a of the first drive unit 111a is disposed in a movable housing 10a2 of the first swivel portion 1102, and the torsion spring 112e is disposed between the movable housing 10a2 and the rotation shaft portion 11a. Note that one end of the torsion spring 112e is fixed to the movable housing 10a2 by a spring fixing tool, and another end of the torsion spring 112e is connected to the rotation shaft portion 11a.

In the first swivel portion 1102, when the rotation shaft portion 11a rotates with respect to the movable housing 10a2 from a reference position (that is, a position where no reaction force is generated) of the rotation shaft portion 11a with respect to the movable housing 10a2, the torsion spring 112e generates reaction force by the rotation. In this case, since the torsion spring 112e is optimized for a rotational motion, it is possible to suppress occurrence of troubles such as buckling of a spring.

### Rotation Stop Mechanism of Contact Portion

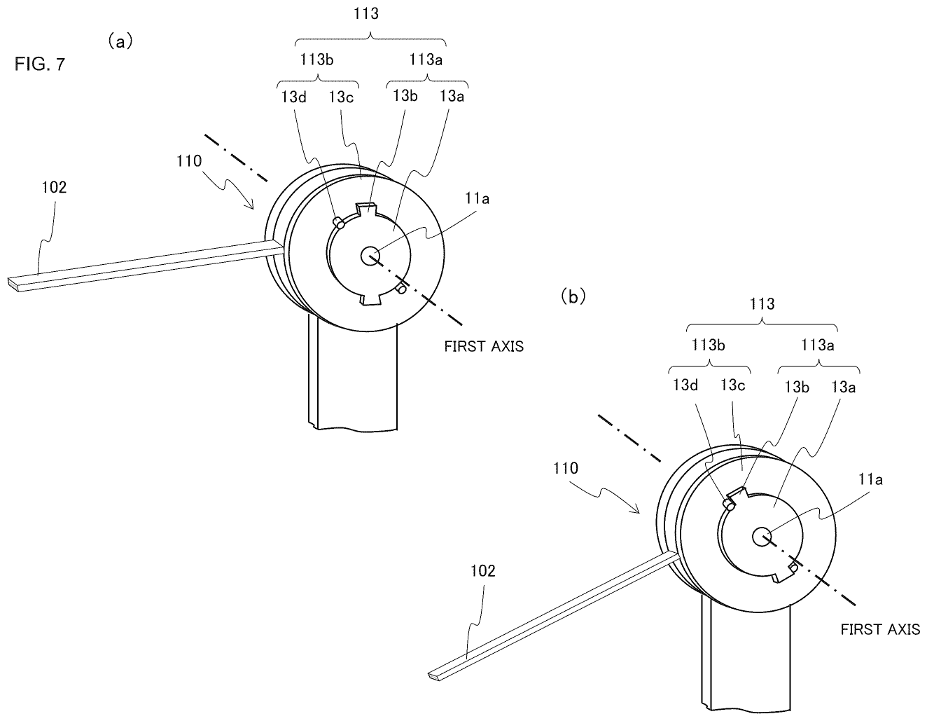

FIGS. 7(a) and 7(b) are schematic diagrams for explaining a rotation stop mechanism 113 of the contact portion in the input unit 100 of the present invention. FIG. 7(a) illustrates a non-operating state of the rotation stop mechanism, and FIG. 7(b) illustrates an operating state of the rotation stop mechanism.

### Swivel Stop Mechanism

As still another haptic function, an input unit 10 may have a function of transmitting a feel (hard reaction force) in a case where a robot hand grips a hard object to an operator. Specifically, this function may be realized by the swivel stop mechanism 113 that stops swivel of the contact portion 102. Here, a specific configuration of the swivel stop mechanism 113 is not limited, and may be optional. However, in one embodiment, as illustrated in FIGS. 3 and 7, the input unit 100 includes the swivel stop mechanism 113 that stops swivel of the contact portion 102.

As illustrated in FIG. 7, the swivel stop mechanism 113 may include a rigid rotation member 113a configured to be rotated about the first axis together with the contact portion 102 by the first drive unit 111a, and a rigid stationary member 113b configured to prevent rotation by an angle equal to or more than a threshold of the rigid rotation member 113a, and may be configured to stop the contact portion 102 by collision of the rigid stationary member 113b with the rigid rotation member 113a when rotation by an angle equal to or more than the threshold of the rigid rotation member 113a occurs. The angle equal to or more than a threshold is, for example, an angle in a range from about 5 degrees to about 25 degrees, and more specifically, about 15 degrees.

Here, the rigid rotation member 113a is, for example, a member fixed to the rotation shaft portion 11a of the first drive unit 111a so as to swivel together with swivel about the first axis of the contact portion 102, and includes a movable main body portion 13a and a locking piece 13b formed on an outer periphery of the movable main body portion 13a.

Further, the rigid stationary member 113b includes, for example, a stationary main body portion 13c that does not rotate even when the rotation shaft portion 11a of the first drive unit 111a rotates, and an abutment piece 13d formed in a part of the stationary main body portion 13c so as to be able to abut on the locking piece 13b of the movable main body portion 13a.

The rotation stop mechanism 113 is configured so that, when the rigid rotation member 113a is about to rotate by a predetermined angle or more from the reference position (see FIG. 7(a)) with respect to the rigid stationary member 113b (see FIG. 7(b)), the locking piece 13b of the rigid rotation member 113a abuts on the abutment piece 13d of the rigid stationary member 113b and rotation of the rigid rotation member 113a stops so that hard reaction force with respect to the contact portion 102 is generated.

Note that the swivel stop mechanism 113 may include a rigid rotation member configured to be rotated about the second axis by the second drive unit 121a and a rigid stationary member corresponding to the rigid rotation member instead of the rigid rotation member 113a configured to be rotated about the first axis by the first drive unit 111a and the rigid stationary member 113b corresponding to the rigid rotation member 113a, or in addition to the rigid rotation member 113a and the rigid stationary member 113b corresponding to the rigid rotation member 113a.

Note that the rotation stop mechanism 113 illustrated in FIG. 7 is configured such that the rigid stationary member 113b collides with the rigid rotation member 113a to generate hard reaction force in the contact portion 102 when rotation by an angle equal to or more than a threshold of the rigid rotation member 113a occurs. However, the rotation stop mechanism 113 illustrated in FIG. 7 may be configured such that friction resistance is generated between the rigid stationary member 113b and the rigid rotation member 113a to generate hard reaction force in the contact portion 102 when rotation by an angle equal to or more than a threshold of the rigid rotation member 113a occurs.

As described above, the input unit of the present invention includes the base portion 101, the contact portion 102 with which the finger 1 of an operator comes into contact, and the detection unit 103 that detects a swivel amount of the contact portion 102 with respect to the base portion 101. Other configurations of the input unit are not particularly limited as long as the detection unit 103 detects a swivel amount of the contact portion 102 with respect to the base portion 101 according to a bending motion, an extending motion, an adduction motion, and an abduction motion of the finger 1 and simultaneously detects a position of a fingertip of the finger 1 on the contact portion 102. Hereinafter, an example of a specific configuration of the input unit of the present invention will be described by exemplifying the input unit 100a of the first embodiment.

### First Embodiment

FIG. 8 is a schematic diagram for explaining the input unit 100a of the first embodiment of the present invention, FIG. 8(a) is a perspective view, and FIG. 8(b) illustrates a cross-sectional structure on an R surface of a contact portion illustrated in FIG. 8(a).

The input unit 100a detects information for operating an index finger of a robot hand 1200 (see FIG. 18) from a motion of an index finger 1a of an operator. As illustrated in FIG. 8(a), the input unit 100a includes the base portion 101 serving as a base of each portion, the contact portion 102 provided to be able to swivel with respect to the base portion 101, and the detection unit 103 that detects a swivel amount of the contact portion 102 with respect to the base portion 101. Hereinafter, a configuration of each portion of the input unit 100a will be described in detail, but the above-described three-dimensional coordinates are used in description of a motion of the contact portion 102 and the like.

### Base Portion 101

Here, the base portion 101 is a portion serving as a base for installing the input unit 100a, and a reference direction B is set in the base portion 101 as illustrated in FIG. 8(a). When an operator places the index finger 1a on the contact portion 102 of the input unit 100a to use the input unit 100a, the reference direction B of the base portion 101 coincides with a width direction (that is, a direction in which four fingers other than a thumb are arranged) of a palm of the operator. During use of the input unit 100a, that is, while the index finger 1a is placed on the contact portion 102 for use of the input unit 100a, the reference direction B and the width direction of the palm of the operator are kept coincident with each other. Furthermore, a surface of the base portion 101 is kept in a state of being parallel to a base surface on which the input unit 100a is installed. Here, the reference direction B is a direction parallel to the width direction of the palm in the initial posture. Note that, as described above, the initial posture is a state in which the finger 1 of an operator is placed on the contact portion 102, and even when the finger is in contact with the contact portion 102, the finger extends straight from the palm, so that the contact portion 102 is held in a posture parallel to a surface of the base portion 101.

### Contact Portion 102

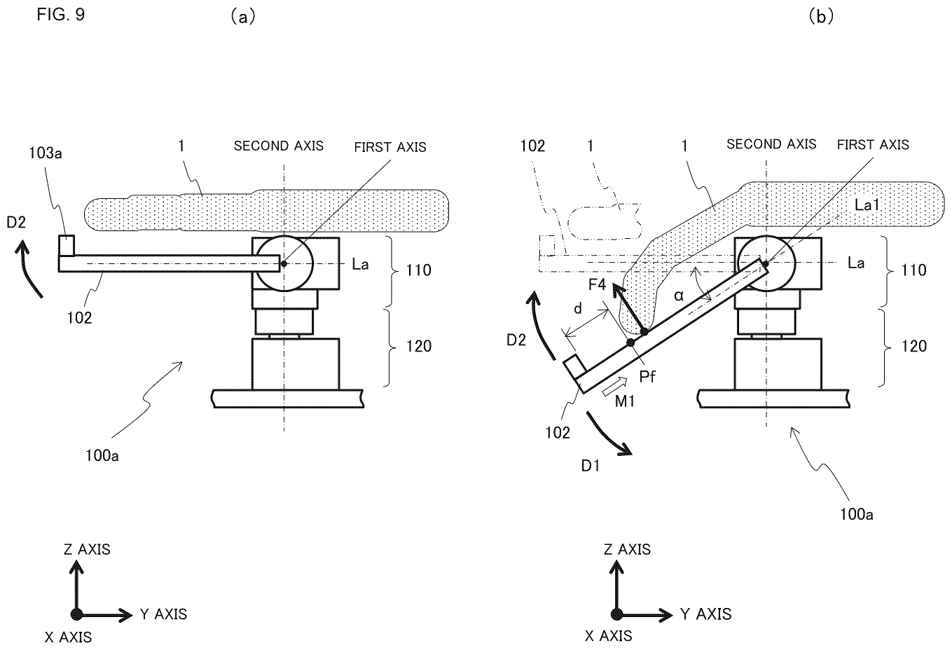

In the input unit 100a, the contact portion 102 is provided so as to be able to swivel about the first axis (about an axis along a width direction of the contact portion 102) and to be able to swivel about the second axis (about an axis along a normal direction of a palm in the initial posture) as illustrated in FIG. 9 with respect to the base portion 101.

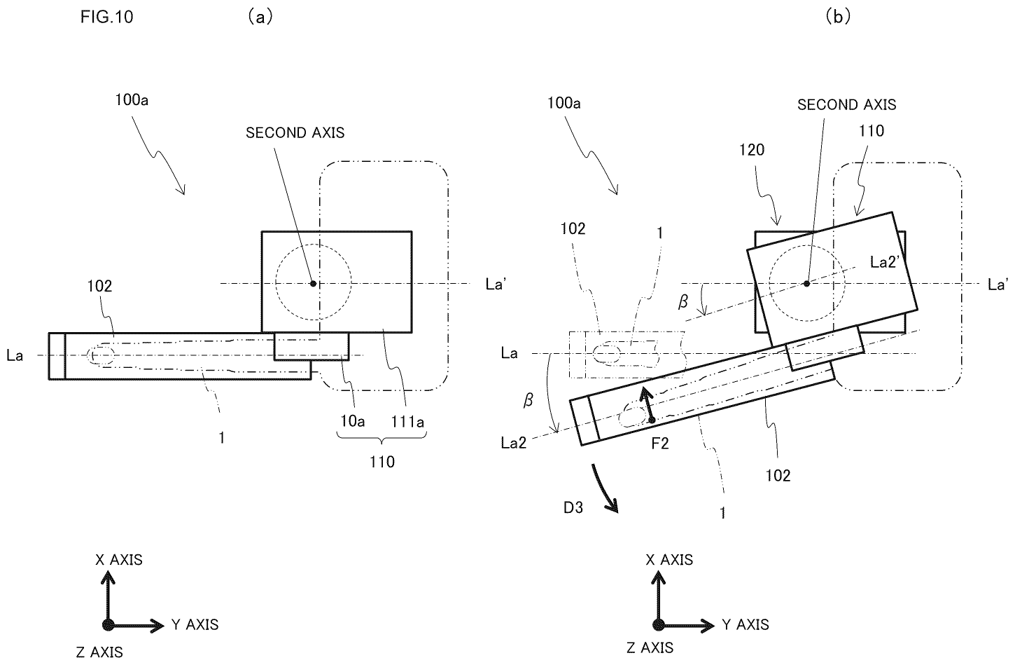

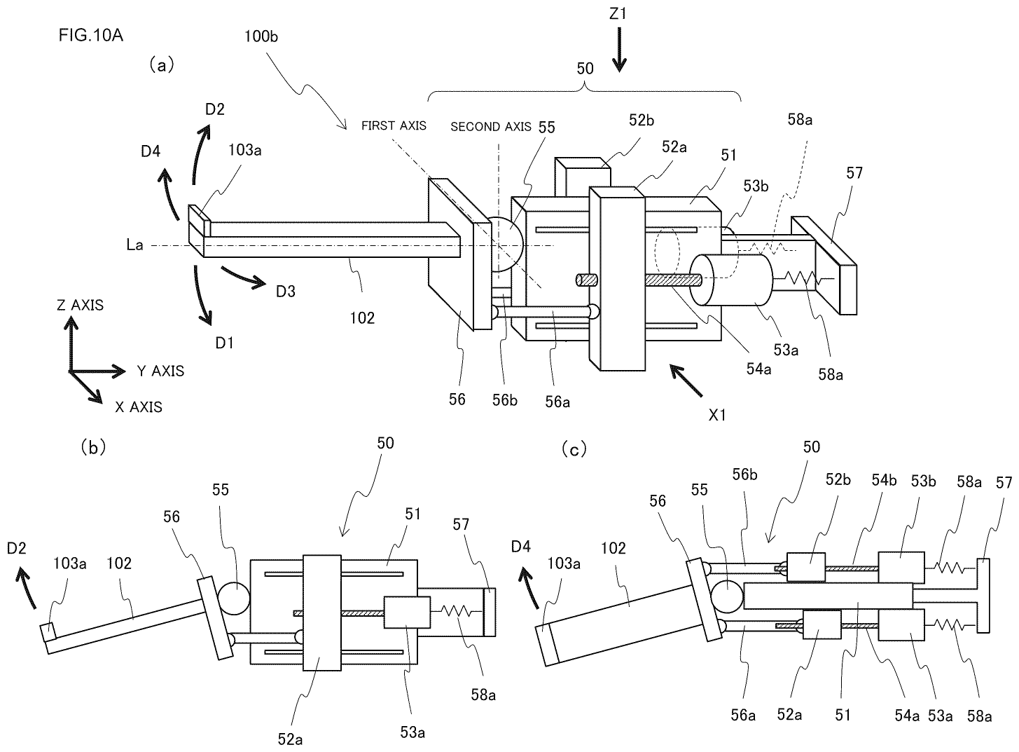

The contact portion 102 is a portion with which a tip of the index finger 1a of an operator comes into contact, and has a structure in which a linear groove 102a is formed along a longitudinal direction on an upper surface of an elongated plate member (a surface on the upper side in the diagram of FIG. 8(a)). In the contact portion 102 having such a structure, when an operator places the index finger 1a on an upper surface of the contact portion 102, a tip of the index finger 1a fits into the linear groove 102a, the contact portion 102 swivels in the first direction D1 according to a bending motion of the index finger 1a, and the tip of the index finger 1a slides in the linear groove 102a as indicated by an arrow M1 (see FIG. 9(b)). Further, in a state in which the tip of the index finger 1a is fitted in the linear groove 102a, the contact portion 102 swivels in the second direction D3 according to adduction and abduction motions (for example, an adduction motion) of the index finger 1a, and the tip of the index finger 1a slides in the linear groove 102a (see FIG. 10(b)).

Furthermore, the position detection unit 103a is attached to a distal end (tip) of the contact portion 102, and the position detection unit 103a is a sensor that detects the distance d from the position detection unit 103a to the tip position Pf of the index finger 1a, and is preferably a non-contact type sensor that does not hinder haptic presentation. For example, an infrared time of flight (TOF) sensor is used. However, the position detection unit 103a may be a position sensor other than an infrared time of flight (TOF) sensor, and furthermore, in some cases, the position detection unit 103a may be a contact type sensor instead of a non-contact type sensor. Here, the position sensor used for the position detection unit is not limited to an infrared TOF, and may be another optical sensor, or a capacitance sensor may be used instead of the optical sensor for the position sensor. For example, a plurality of optical sensors or capacitance sensors may be arranged on the contact portion 102 along a longitudinal direction of the contact portion 102.

As described above, in the input unit 100a, the configuration in which the contact portion 102 is able to swivel about the first axis (axis along a width direction of the contact portion 102) and is able to swivel about the second axis (axis along a normal direction of a palm) with respect to the base portion 101 as illustrated in FIG. 9 is substantially realized by the input unit 100a including the first swivel portion (first actuator) 110 that supports the contact portion 102 in a manner being able to swivel about the first axis with respect to the base portion 101 and the second swivel portion (second actuator) 120 that supports the contact portion 102 in a manner being able to swivel about the second axis with respect to the base portion 101. Details will be described below.

### First Swivel Portion (First Actuator) 110

Here, the first actuator 110 includes the first movable portion 10a that swivels about a first swivel axis parallel to a surface of the base portion 101, and the first drive unit 111a that swivels the first movable portion 10a. Here, the first axis is an axis along a width direction of a palm of an operator in the initial posture in which the index finger 1a is placed on the contact portion 102 for use of the input unit 100a.

A rotation shaft portion of the first drive unit 111a is attached to the first movable portion 10a, the first movable portion 10a is able to swivel about the first axis as a central axis, and one end (proximal end) of the contact portion 102 is fixed to the first movable portion 10a. That is, the rotation shaft portion 11a of the drive unit 111a of the first swivel portion 110 coincides with the first axis, and the first swivel portion 110 swivels the contact portion 102 about the first axis.

Here, the first drive unit 111a is a drive source for generating reaction force in the contact portion 102, the rotation shaft portion 11a of the first drive unit 111a is connected to the first movable portion 10a with the elastic member 112 interposed between them as illustrated in FIG. 4, and drive force of the first drive unit 111a is transmitted to the first movable portion 10a via the elastic member 112, so that reaction force in bending and extending directions (the first and second directions D1 and D2) is generated in the contact portion 102 connected to the first swivel portion 110.

Further, the first swivel amount detection unit 131 and the first force detection unit 111b are incorporated in the first movable portion 10a.

When an operator bends the index finger 1a from the initial posture (FIG. 9(a)) in which the index finger 1a is extended (see FIG. 9(b)), the first swivel amount detection unit 131 detects an angle α at which the contact portion 102 swivels about the first axis (axis parallel to the X axis in the initial posture) as a swivel amount of the contact portion 102. Here, a magnetic encoder is used, but an optical encoder may be used.

The first force detection unit 111b has a configuration of including the elastic member 112 as illustrated in FIG. 4. Here, the elastic member includes the first elastic member 112a and the second elastic member 112b as illustrated in FIG. 5.

Since the input unit 100a includes the first force detection unit 111b, reaction force generated at the time of bending and extending motions of the index finger 1a of an operator can be feedback-controlled.

### Rotation Stop Mechanism 113

Furthermore, the input unit 100a includes the rotation stop mechanism 113 described above, and when rotation of the contact portion 102 about the first axis by a motion of a finger reaches a certain amount at the first swivel portion 110, the rotation stop mechanism 113 stops swivel of the contact portion 102 by the motion of the finger, so that hard reaction force (a feel when a robot hand grips a hard object) is generated in the contact portion 102.

### Second Swivel Portion (Second Actuator) 120

The second swivel portion 120 includes a second movable portion 20a that supports the contact portion 102 so as to be able to swivel about the second axis, and the second drive unit 121a that drives the movable portion 20a. Here, the second axis is an axis along a normal direction of a palm of an operator in the initial posture, that is, in a state where the index finger 1a is placed on the contact portion 102 for use of the input unit 100a.

A rotation shaft portion of the second drive unit 121a is attached to the second movable portion 20a, the second movable portion 20a is able to swivel about the second axis as a central axis, and the first swivel portion 110 is supported by a coupling portion 140 fixed to the second movable portion 20a. That is, the center of the rotation shaft portion of the drive unit 121a of the second swivel portion 120 coincides with the second axis, and the second swivel portion 120 swivels the contact portion 102 about the second axis.

Here, the second drive unit 121a is a drive source for generating reaction force in the contact portion 102, the rotation shaft portion of the second drive unit 121a is connected to the second movable portion 20a with the elastic member 112 (see FIG. 4) interposed between them, and drive force of the second drive unit 121a is transmitted to the second movable portion 20a via the elastic member 112, so that reaction force in adduction and abduction directions is generated in the contact portion 102 connected to the second swivel portion 120 via the first swivel portion 110.

Further, the second swivel amount detection unit 132 and the second force detection unit 121b are incorporated in the second movable portion 20a.

The second swivel amount detection unit 132 detects an angle β at which the contact portion 102 swivels about the second axis as a second swivel amount of the contact portion 102 when an operator adducts the index finger 1a from the initial posture (FIG. 10(a)) in which the index finger 1a is extended (see FIG. 10(b)). A magnetic encoder is used here, but an optical encoder may be used.

Here, the second force detection unit 121b has a configuration of including the elastic member 112 as illustrated in FIG. 4, and the elastic member includes the first elastic member 112a and the second elastic member 112b illustrated in FIG. 5.

Since the input unit 100a includes the second force detection unit 121b, reaction force generated at the time of adduction and abduction motions of the index finger 1a of an operator can be feedback-controlled.

Next, operation of the input unit 100 of the first embodiment illustrated in FIG. 8 will be described.

First, operation of detecting a bending motion of the index finger 1a will be described.

FIGS. 9(a) and 9(b) are diagrams for explaining a motion of the contact portion 102 according to a bending motion of a finger of an operator in the input unit 100 illustrated in FIGS. 8(a) and 8(b). FIG. 9(a) illustrates a state in which the finger 1 is extended (initial posture), and FIG. 9(b) illustrates a state in which the finger 1 is bent (motion state).

In the initial posture in which the finger (specifically, the index finger) 1 of an operator is extended, even if the finger 1 of the operator is placed on the contact portion 102, the contact portion 102 does not swivel downward by the finger 1, so that the contact portion 102 is held in a state horizontal with respect to a surface of the base portion 101. Note that, in this state, since downward force due to its own weight acts on the contact portion 102, the first drive unit 111a generates torque in the first direction D1 so that the contact portion 102 is held in a horizontal reference posture (posture in which the longitudinal axis La is parallel to a surface of the base portion 101). Note that holding the contact portion 102 in the horizontal reference posture (posture parallel to a surface of the base portion 101) may be performed not by torque by the first drive unit 111a but by biasing force by a spring.

In this state, as illustrated in FIG. 9(b), when an operator bends the finger 1, a fingertip of the finger 1 presses the contact portion 102 downward, and the contact portion 102 swivels in the first direction D1 about the first axis. By the above, the longitudinal axis La of the contact portion 102 in the initial posture becomes the longitudinal axis La1 after a bending motion inclined with respect to the horizontal direction. Further, on the contact portion 102, the finger 1 of an operator moves in a direction of the arrow M1.

At this time, the first swivel amount detection unit (magnetic encoder) 131 detects, as a first swivel amount, the rotation angle α (an angle formed by the longitudinal axis La and the longitudinal axis La1) rotated from the reference posture (posture of the initial posture) of the contact portion 102, and the position detection unit 103a further detects, as the position Pf of the finger 1, the distance d from the position detection unit 103a to the position Pf of a fingertip of the finger 1 of an operator. The detection unit 103 calculates the angles K1 to K3 (see FIG. 2) of joints of the finger 1 based on inverse kinematics from the distance d and the rotation angle α. Note that angle information of each joint of the finger 1 calculated in this manner is transmitted, as motion information of the finger 1 of an operator, from the input unit 100a to the robot hand 1200 (see FIG. 18).

In a state where the robot hand 1200 grips nothing, information for haptic presentation is not provided from the robot hand 1200 to the input unit 100a side, and the first drive unit 111a does not generate torque for generating reaction force. For this reason, no reaction force is applied from the contact portion 102 to the finger 1 of an operator, and the contact portion 102 swivels downward (in the first direction D1) in accordance with bending of the finger 1 of an operator.

On the other hand, when a robot hand grips an object by swivel of the contact portion 102, force sense information is transmitted from the robot hand to the input unit 100a.

When the input unit 100a receives the force sense information, the first drive unit 111a drives the first movable portion 10a so as to generate reaction force for rotating the contact portion 102 in the second direction D2. At this time, in the first force detection unit 111b, as described in FIG. 4, the first displacement amount detection unit 111c detects the displacement amount ΔL of the elastic member 112 based on a rotation amount of a servo motor serving as the first drive unit 111a, and calculates magnitude of reaction force generated in the contact portion 102 based on Hooke's law from the displacement amount ΔL. The first displacement amount detection unit 111c feedback-controls the first drive unit 111a so that magnitude of the calculated reaction force becomes magnitude of reaction force indicated by the received force sense information. Further, at this time, reaction force may be adjusted by calculating torque according to a position of the finger on the contact portion 102.

By the above, in the input unit 100a, an operator can clearly sense, as reaction force generated in the contact portion 102, a feel of a robot hand gripping an object.

Then, when the contact portion 102 further swivels by a bending motion of the finger 1 and swivels by a certain amount, the rigid stationary member 113b collides with the rigid rotation member 113a to stop the contact portion 102. By the above, an operator obtains a feel that a robot hand grips a hard object.

Next, operation of detecting an adduction motion of the finger 1 will be described.

FIG. 10 is a diagram for explaining a motion of the contact portion 102 according to an adduction motion of a finger of an operator in the input unit 100 illustrated in FIG. 8. FIG. 10(a) illustrates the initial posture in which the finger 1 is parallel to a palm and extends straight from the palm (that is, in parallel with the Y axis), and FIG. 10(b) illustrates a state in which the finger 1 is adducted from the initial posture by the predetermined angle β. Note that, in the diagram, La indicates a longitudinal axis of the contact portion 102 in the initial posture, and La2 indicates a longitudinal axis of the contact portion 102 after an adduction motion. Further, La′ is a straight line parallel to the longitudinal axis La and passing through the second axis, and La2′ is a straight line parallel to the longitudinal axis La′ and passing through the second axis.

In the initial posture (FIG. 10(a)) in which the finger 1 of an operator extends, even if the finger 1 of an operator is placed on the contact portion 102, the contact portion 102 is not pressed by the finger 1 and does not swing left and right, and thus is held in a direction in which the finger 1 protrudes from a palm (direction parallel to the Y axis).

In this state, as illustrated in FIG. 10(b), when the operator adducts the finger 1, a fingertip of the finger 1 presses the contact portion 102 in an adduction direction, and the contact portion 102 moves in the third direction D3 about the second axis.

At this time, in the detection unit 103, the second swivel amount detection unit (magnetic encoder) 132 detects, as the second swivel amount, the rotation angle β (angle formed by the straight line La′ and the straight line La2′) of the contact portion 102 swiveled in an adduction direction from a posture of the initial posture. Information on an adduction angle of the finger 1 detected in this manner is transmitted to the robot hand 1200 (see FIG. 18) as motion information on the finger 1 of an operator.

In a state where the robot hand 1200 grips nothing, information for haptic presentation is not provided from the robot hand 1200 to the input unit 100a side, and the second drive unit 121a does not generate torque for generating reaction force. For this reason, no reaction force from the contact portion 102 is applied to the finger 1 of an operator, and the contact portion 102 swivels in an adduction direction (third direction D3) in accordance with adduction of the finger 1 of an operator as illustrated in FIG. 10(b).

When the robot hand grips an object by the swivel of the contact portion 102 in an adduction direction, force sense information in adduction is transmitted from the robot hand to the input unit 100a.

When the input unit 100a receives the force sense information in adduction, the second drive unit 121a drives the second movable portion 20a so as to generate reaction force for rotating the contact portion 102 in the D4 direction. At this time, in the second force detection unit 121b, similarly to the first force detection unit 111b described above, a second displacement amount detection unit (not illustrated) detects the displacement amount ΔL of an elastic member from a rotation amount of a servo motor as the second drive unit 121a based on the rotation amount, and calculates magnitude of reaction force in the fourth direction D4 generated in the contact portion 102 from the displacement amount ΔL based on Hooke's law. The second displacement amount detection unit (not illustrated) feedback-controls the second drive unit 121a so that the calculated magnitude of reaction force becomes magnitude of reaction force indicated by the received force sense information.

By the above, in the input unit 100a, an operator can clearly sense, as reaction force of an adduction motion generated in the contact portion 102, a feel of a robot hand gripping something by an adduction motion of the finger 1.

Then, when the contact portion 102 further swivels by an adduction motion of the finger 1 and swivels by a certain amount, similarly to the case of a bending motion of the finger 1, a rigid stationary member (not illustrated) included in the second swivel portion 120 collides with a rigid rotation member (not illustrated), so that hard reaction force (feel of a robot hand gripping a hard object) in an adduction motion is obtained in the contact portion 102.

Note that the input unit 100 of the first embodiment includes, as a mechanism for swiveling the contact portion 102 about the first axis and about the second axis, the first swivel portion 110 that swivels the contact portion 102 about the first axis with respect to the base portion 101 and the second swivel portion 120 that swivels the contact portion 102 about the second axis with respect to the base portion 101. However, instead of such two swivel portions, one swivel portion capable of swiveling the contact portion 102 about the first axis and about the second axis may be used.

FIG. 10A is a diagram illustrating an alternative configuration example of a swivel portion in the input unit 100 of the first embodiment illustrated in FIG. 8, FIG. 10A(a) is a perspective view, and FIGS. 10A(b) and 10A(c) are plan views illustrating a structure in which an operating state of a drive unit illustrated in FIG. 10A(a) is viewed from an X1 direction and a Z1 direction, respectively.

This input unit 100b includes, instead of the first swivel portion 110 and the second swivel portion 120 in the input unit 100a illustrated in FIG. 8, one swivel portion (actuator) 50 that supports the contact portion 102 so as to be able to swivel about both the first axis and the second axis with respect to the base portion 101. Here, the first axis is an axis parallel to a width direction of the contact portion 102 of the input unit 100b, and the second axis is an axis parallel to a normal direction of a surface of the contact portion 102 of the input unit 100b.

Note that, in the input unit 100b as well, three-dimensional coordinates including the X axis, the Y axis, and the Z axis are used to clarify a direction of an axis (swivel axis) when the contact portion 102 swivels. In the initial posture, the first axis is parallel to the X axis (axis parallel to a width direction of a palm when the index finger 1 is placed on the contact portion 102), the second axis is parallel to the Z axis (axis parallel to a normal direction of a palm when the index finger 1 is placed on the contact portion 102), and a longitudinal axis of the contact portion 102 is parallel to the Y axis.

The swivel portion 50 includes a base block 51, a first slide block 52a and a second slide block 52b attached to both side portions of the base block 51 so as to be slidable in a Y-axis direction, and a support body 56 that supports the contact portion 102. The support body 56 is connected to a tip of the base block 51 with a universal joint 55 interposed between them, and the first and second slide blocks 52a and 52b are coupled to the support body 56 by first and second coupling rods 56a and 56b. Note that connection between the support body 56 and the first and second coupling rods 56a and 56b and connection between the first and second coupling rods 56a and 56b and the first and second slide blocks 52a and 52b are connection that allows posture change of a coupling rod with respect to the support body 56 and posture change of a coupling rod with respect to a slide block. Further, connection positions of the support body 56 with the first coupling rod 56a, the second coupling rod 56b, and the universal joint 55 are desirably, but without limitation to, positions of vertices of an isosceles triangle having a connection position with the universal joint 55 as a vertex. However, in a case where a connection position between the universal joint 55 and the support body 56 is at the same position as a connection position between the coupling rods 56a and 56b and the support body 56 in the Z direction, the contact portion 102 cannot rotate about the X axis, and this case should be avoided. Further, in relation to a positional relationship between two of the coupling rods 56a and 56b, at a moment when the coupling rod 56a and the coupling rod 56b are parallel, that is, at a moment when force exerted on the support body 56 by the coupling rod 56a and force exerted on the support body 56 by the coupling rod 56b are balanced, rotation holding force about the Z axis (force maintaining rotation about the Z axis of the contact portion 102) is lowered, and thus such a situation should be avoided as much as possible.

Further, the swivel portion 50 includes a first ball screw 54a screwed to the first slide block 52a, a second ball screw 54b screwed to the second slide block 52b, a first motor 53a that rotates the first ball screw 54a, a second motor 53b that rotates the second ball screw 54b, and a support member 57 attached to another end (proximal end) of the base block 51.

Here, the first and second motors 53a and 53b are attached to the base block 51 so as to be slidable in the Y-axis direction, and are connected to the support member 57 with corresponding biasing springs 58a and 58b interposed between them.

Note that in the initial posture, the swivel portion 50 is configured such that two of the slide blocks 52a and 52b are located at the same reference position in the Y-axis direction with respect to the base block 51.

Further, the input unit 100b includes a slide amount detection unit (not illustrated) that detects a slide amount from a reference position in the Y-axis direction of two of the slide blocks 52a and 52b instead of the first and second swivel amount detection units of the input unit 100. The slide amount detection unit may be incorporated in the swivel portion 50 or may be provided outside the swivel portion 50. Further, an optical or mechanical distance sensor can be used as the slide amount detection unit.

In the swivel portion 50 having such a configuration, when the support body 56 swivels about the first axis with a universal joint as a fulcrum due to a motion about the first axis of the contact portion 102 accompanying a bending motion of a finger of an operator in the initial posture, two of the slide blocks 52a and 52b simultaneously slide in the same direction. The slide amount detection unit detects slide amounts of two of the slide blocks to detect a swivel amount about the first axis of the contact portion 102. Further, the position detection unit 103a can detect a position of the finger 1 on the contact portion 102 similarly to the input unit 100a illustrated in FIG. 8. Therefore, from these detection results, an angle at each joint of the finger 1 can be calculated similarly to the input unit 100a illustrated in FIG. 8.

Further, by simultaneously pressing the first and second slide blocks 52a and 52b to the front side by driving the first and second motors 53a and 53b, it is possible to generate reaction force in the second direction D2 that is the opposite direction to the bending direction D1 in the contact portion 102 as illustrated in FIG. 10A(b). In this case, in the input unit 100b as well, similarly to the first force detection unit 111b of the input unit 100a, magnitude of reaction force is detected and feedback control is performed based on force sense information from a robot hand, so that reaction force to be generated can be set to magnitude corresponding to the force sense information.

Further, in the swivel portion 50, when the support body 56 swivels about the second axis with the universal joint 55 as a fulcrum due to a motion about the second axis of the contact portion 102 accompanying an adduction motion of a finger of an operator, the first slide block 52a slides to the side opposite to a fingertip, and the second slide block 52b slides to the fingertip side. By detection of slide amounts of two slide blocks by the slide amount detection unit, it is possible to detect a swivel amount about the second axis of the contact portion 102. Similarly to the input unit 100a illustrated in FIG. 8, an adduction angle can be calculated from the detection result.

Further, in this case, by pressing the first slide block 52a forward and pulling the second slide block 52b backward by driving of the first and second motors 53a and 53b, as illustrated in FIG. 10A(c), reaction force in the fourth direction D4 can be generated in the contact portion 102.

In this case, in the input unit 100b as well, similarly to the second force detection unit 121b of the input unit 100a, magnitude of reaction force is detected and feedback control is performed based on force sense information from a robot hand, so that reaction force to be generated can be set to magnitude corresponding to the force sense information.

The input unit 100 of the present invention described above assumes a finger other than a thumb, and in a case where the input unit 100 is applied to a thumb, in order to detect a unique motion of a thumb 2, it is preferable to have a configuration suitable for a motion of a thumb in addition to the configuration of the input unit 100 illustrated in FIG. 1.

This is because, unlike other fingers, a thumb usually applies force in a direction in which the contact portion 102 is lifted when gripping an object, and in addition to bending and extending motions and adduction and abduction motions, a motion of swiveling around an axis along a direction in which the thumb extends (a twisting motion of a finger) may also occur for the thumb.
[2] The thumb input unit 200 will be described.

In view of the above, hereinafter, the thumb input unit 200 will be described as an input unit of the present invention. Also in this description, the three-dimensional coordinates used in the description of the input unit in FIG. 1 are used to clarify a direction of an axis when the contact portion 202 swivels.

FIG. 11 is a schematic diagram illustrating a basic configuration of the thumb input unit 200 corresponding to the thumb 2 as a basic configuration of the input unit of the present invention. FIG. 11(a) illustrates a state in which the thumb 2 is placed on the thumb input unit 200, and FIG. 11(b) illustrates the swivel directions D1 to D6 of the contact portion 202 accompanying a motion of the thumb 2.

As illustrated in FIGS. 11(a) and 11(b), the thumb input unit 200 includes the thumb contact portion 202 suitable for a motion of a thumb instead of the contact portion 102 in the input unit 100 illustrated in FIG. 1, further includes a third swivel portion 230 in addition to the first swivel portion 110 and the second swivel portion 120 in the input unit 100, and includes a detection unit 203 in place of the detection unit 103 in the input unit 100.

### Third Swivel Portion

Here, the third swivel portion 230 is an actuator that enables swivel about a third axis of the thumb contact portion 202 corresponding to a twisting motion of a thumb. Here, the third axis is an axis (longitudinal axis La) parallel to an extending direction of the thumb contact portion 202. The third axis is an axis parallel to the Y axis of the three-dimensional coordinates described in FIG. 1 in the initial posture. Note that the X axis and the Z axis of the three-dimensional coordinates are as defined in the description of FIG. 1. Here, when transition is made from the initial posture to a motion state (bending and extending state) in which the thumb contact portion 202 swivels about the first axis, the third axis becomes an axis inclined in a YZ plane with respect to the Y axis, and when transition is made from the initial posture to a motion state (adduction and abduction motion state) in which the thumb contact portion 202 swivels about the second axis, the third axis becomes an axis inclined in the XY plane with respect to the Y axis.

That is, since the third axis is parallel to the Y axis in the initial posture, swivel of the thumb contact portion 202 accompanying a twisting motion of a thumb from the initial posture is performed about the Y axis.

On the other hand, in a case where the thumb contact portion 202 swivels about the first axis along with bending and extending of a thumb from the initial posture and then the thumb contact portion swivels about the third axis along with a twisting motion of the thumb, the third axis is not parallel to the Y axis in this state. For this reason, the thumb contact portion swivels about the third axis inclined with respect to the Y axis in the YZ plane instead of the Y axis. In a case where the thumb contact portion 202 swivels about the second axis along with adduction and abduction of a thumb from the initial posture and then the thumb contact portion swivels about the third axis along with a twisting motion of the thumb, the third axis is not parallel to the Y axis in this state. For this reason, the thumb contact portion swivels about the third axis inclined with respect to the Y-axis in the XY plane instead of the Y axis.

Note that, in the thumb input unit 200, the first swivel portion 110 and the second swivel portion 120 are coupled by the coupling portion 104, and a second swivel portion 220 and the third swivel portion 230 are coupled by another coupling portion 205. However, a configuration of coupling adjacent swivel portions is not limited, and the first swivel portion 110 and the second swivel portion 120 may be directly coupled, and the second swivel portion 120 and the third swivel portion 230 may be directly coupled.

With such a configuration, the thumb contact portion 202 is configured to swivel about the first axis (about an axis parallel to a width direction of the thumb contact portion 202), about the second axis (about an axis parallel to a normal line of a surface of a base portion of the thumb contact portion 202), and about the third axis (about the longitudinal axis La of the thumb contact portion 202) with respect to the base portion 101 according to bending and extending motions, adduction and abduction motions, and a twisting motion of the thumb 2.

Note that, here, the thumb 2 is assumed to be the thumb of a right hand.

### Detection Unit

The detection unit 203 is configured to detect a swivel amount about the first axis of the thumb contact portion 202, a swivel amount about the second axis of the contact portion 202, a swivel amount about the third axis of the contact portion 202, and a position of a fingertip of the thumb 2 on a contact portion main body 202a of the thumb contact portion 202.

That is, the detection unit 203 substantially includes, as illustrated in FIG. 11(b), the position detection unit 103a that detects a position of a fingertip of the thumb 2 on the contact portion 202, the first swivel amount detection unit 131 that detects a swivel amount about the first axis of the thumb contact portion 202 (about an axis parallel to a width direction of the thumb contact portion 202), the second swivel amount detection unit 132 that detects a swivel amount about the second axis of the thumb contact portion 202 (about an axis parallel to a normal line of a surface of the base portion 101), and a third swivel amount detection unit 233 that detects a swivel amount about the third axis of the thumb contact portion 202 (about an axis of a longitudinal axis of the thumb contact portion 202). Here, similarly to the first swivel amount detection unit 131 and the second swivel amount detection unit 132, the third swivel amount detection unit 233 may be incorporated in the third swivel portion 230 or may be provided outside the third swivel portion 230.

### Thumb Contact Portion 202

Further, as illustrated in FIG. 11(a), the thumb contact portion 202 includes a contact portion main body 202a, a fingertip holding portion 202c configured to hold a fingertip of the thumb 2, and a movable body 202b coupled to the fingertip holding portion 202c, and the movable body 202b is configured to be movable along an extending direction of the contact portion main body 202a (direction of the longitudinal axis La) according to movement of a fingertip held by the fingertip holding portion 202c.

Here, the fingertip holding portion 202c is, for example, a thumb holder configured to hold a fingertip in a state where the fingertip of a finger is fitted.

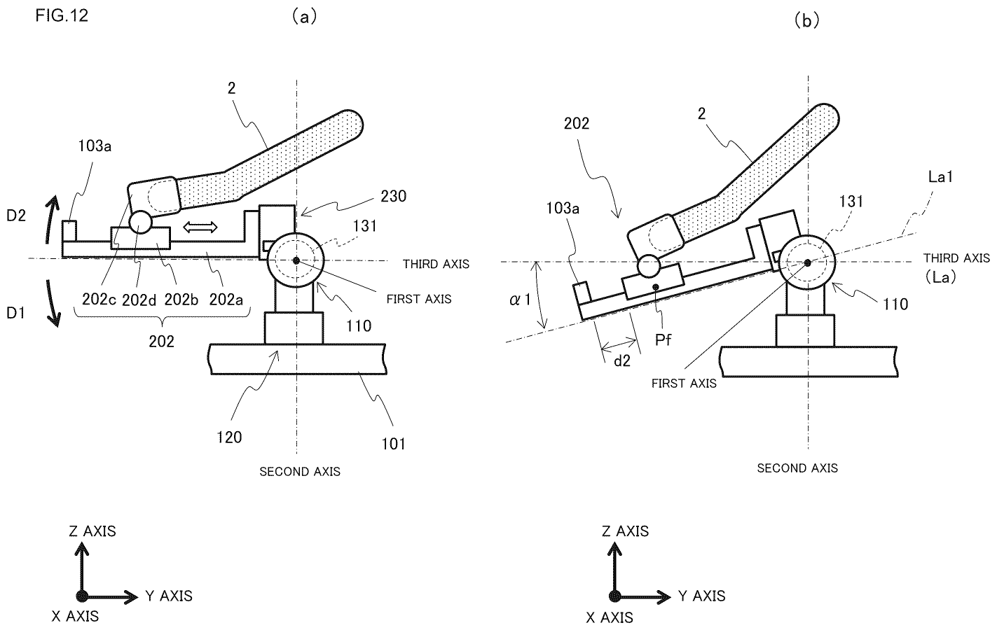

The movable body 202b is a slider slidably attached to the contact portion main body 202a, and the movable body 202b and the fingertip holding portion 202c are coupled by a ball joint 202d (see FIG. 12(a)). Here, the movable body 202b and the fingertip holding portion 202c may be coupled by a universal joint instead of the ball joint 202d.

As described above, in the thumb input unit 200, since the movable body 202b is movable together with the thumb 2 on the contact portion main body 202a of the thumb contact portion 202, the position detection unit 203a may detect a position of a fingertip of the thumb 2 by detecting a position of the movable body 202b moving on the contact portion main body 202a of the thumb contact portion 202. However, the position detection unit 203a may directly measure and detect a position of a fingertip of the thumb 2.

In the input unit 200 of the present invention having such a configuration, not only bending and extending motions and adduction and abduction motions of the thumb 2 of an operator but also motions of the thumb 2 including a twisting motion of the thumb 2 can be accurately detected. Hereinafter, a function of detecting such a motion of the thumb 2 will be described.

FIGS. 12 to 14 are plan views illustrating a motion of a contact portion in the thumb input unit 200 illustrated in FIG. 11. FIG. 12(a) illustrates a structure of the thumb input unit 200 in a state (initial posture) illustrated in FIG. 11(a) as viewed from the X direction illustrated in FIG. 11(b). FIG. 12(b) illustrates a state in which the thumb 2 is swiveled by a predetermined angle α1 in the first direction (bending direction) D1 from the initial posture illustrated in FIG. 12(a). In the diagram, La represents a longitudinal axis of the thumb contact portion 202 in the initial posture, and La1 represents a longitudinal axis of the thumb contact portion 202 after the thumb 2 is bent.

In the thumb input unit 200, as illustrated in FIG. 12, when the thumb 2 is bent and a tip of the thumb 2 moves downward in the diagram, the longitudinal axis La of the contact portion main body 202a of the contact portion 202 swivels from a state parallel to the Y axis to a state forming the angle α1 with respect to the Y axis, and becomes the longitudinal axis La1.

For this reason, the angle α1 between the longitudinal axis La and the longitudinal axis La1 is detected by the first swivel amount detection unit 131, and the position detection unit 203a detects the position Pf of the thumb 2 on the contact portion main body 202a as a distance d2 from the position detection unit 103a to the movable body 202b, so that angles of a first joint and a second joint of the thumb 2 can be obtained from these detection values based on inverse kinematics.

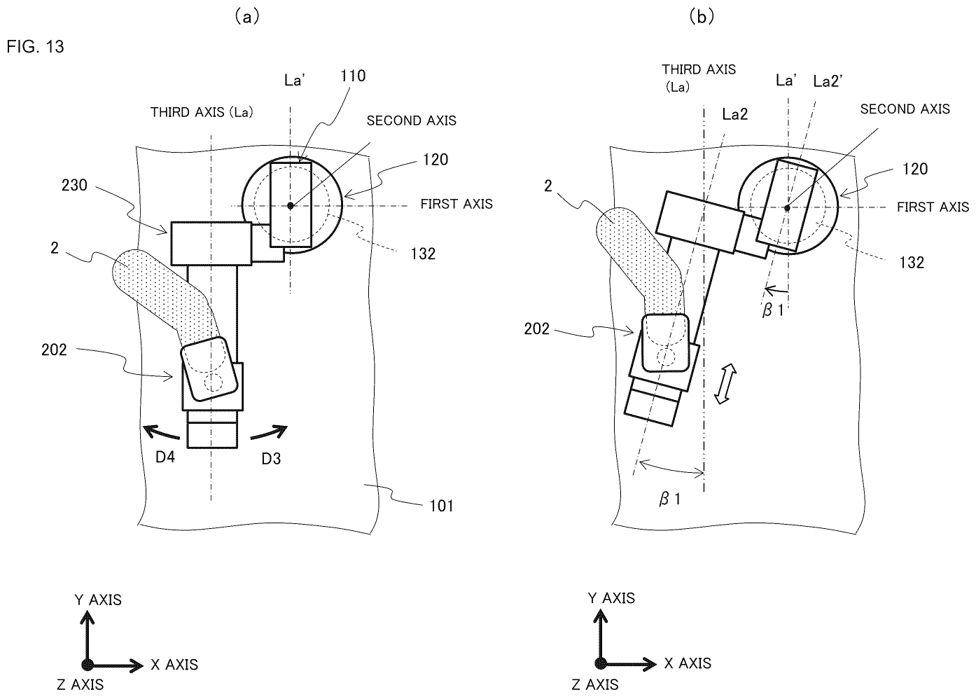

FIG. 13(a) illustrates a structure in which the thumb input unit 200 in the state illustrated in FIG. 11(a) (initial posture) is viewed from the Z direction illustrated in FIG. 11(b), and FIG. 13(b) illustrates a state in which the thumb 2 is swiveled by a predetermined angle β1 in the fourth direction (adduction direction) D4 from the initial posture illustrated in FIG. 13(a). In the diagram, La represents a longitudinal axis of the thumb contact portion 202 in the initial posture, and La2 represents a longitudinal axis of the thumb contact portion 202 after the thumb 2 is adducted. La′ is a straight line parallel to the longitudinal axis La and passing through the second axis, and La2′ is a straight line parallel to the longitudinal axis La2 and passing through the second axis.

In the thumb input unit 200, when the thumb 2 is adducted as illustrated in FIGS. 13(a) and 13(b), the second swivel amount detection unit 132 detects the angle β1 formed by the straight line La2′ and the straight line La′ as an angle formed by the longitudinal axis La of the contact portion main body 202a in the initial posture and the longitudinal axis La2 of the contact portion main body 202a after adduction, so that the second swivel amount (swivel amount about the second axis) of the thumb contact portion 202 can be detected.

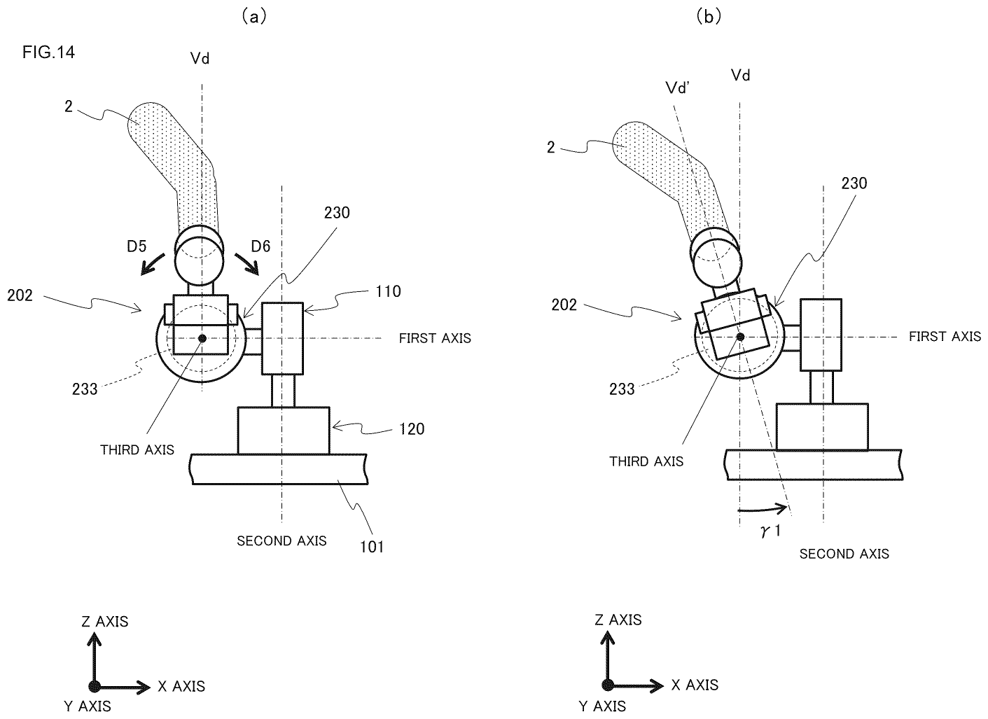

FIG. 14(a) illustrates a structure of the thumb input unit 200 in a state (initial posture) illustrated in FIG. 11(a) as viewed from the Y direction illustrated in FIG. 11(b). FIG. 14(b) illustrates a state in which the thumb 2 is swiveled by a predetermined angle γ1 in the fifth direction (inward twisting direction) D5 from the initial posture illustrated in FIG. 14(a). In the diagram, Vd denotes a normal line of an upper surface of the contact portion main body 202a in the initial posture, and Vd′ denotes a normal line of the upper surface of the contact portion main body 202a after a twisting motion of the thumb 2.

In the thumb input unit 200, when the thumb 2 is twisted inward as illustrated in FIGS. 14(a) and (b), the third swivel amount detection unit 233 detects the angle γ1 formed by the normal Vd of an upper surface of the contact portion main body 202a in the initial posture and the normal Vd′ of the upper surface of the contact portion main body 202a after a twisting motion of the thumb 2, so that a third swivel amount of the thumb contact portion 202 (swivel amount about the longitudinal axis La of the thumb contact portion 202) can be detected.

Therefore, the thumb input unit 200 of the present invention includes the base portion 101, the thumb contact portion 202 with which a thumb of an operator is in contact, and the detection unit 203 that detects a swivel amount of the thumb contact portion 202 with respect to the base portion 101, and other configurations are not particularly limited and may be optional as long as the detection unit 203 detects a swivel amount of the thumb contact portion 202 with respect to the base portion 101 according to a bending motion, an extending motion, an adduction motion, an abduction motion, and left and right twisting motions of a finger and simultaneously detects a position of a fingertip of a thumb on the thumb contact portion.

That is, by having such a configuration, the input unit of the present invention can estimate a posture of a thumb based on inverse kinematics from a swivel amount of the thumb contact portion 202 with respect to the base portion 101 detected by the detection unit 203 and a position of a fingertip of the thumb 2 on the thumb contact portion 202, and as a result, a motion of a part including multiple joints such as a thumb of an operator can be detected from swivel information of the part and position information of the thumb of the operator.

In this case, it is not necessary to provide a configuration for detecting a bending angle of a joint for each joint, and it is also easy to add a configuration for an additional function such as haptics.

Hereinafter, the thumb input unit 200 of the present invention will be conceptually further described.

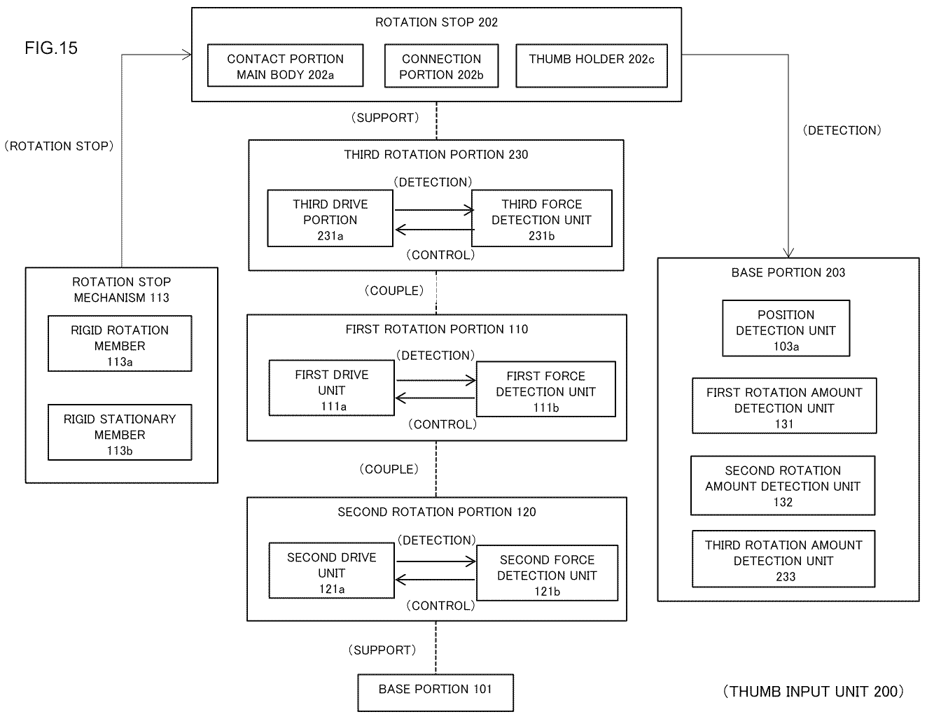

FIG. 15 is a block diagram illustrating a basic constituent element of the input unit 200 of the present invention.

Preferably, the thumb input unit 200 further includes a drive unit that generates reaction force against a swivel about at least one of the first axis, the second axis, and the third axis in the thumb contact portion 202.

That is, as illustrated in FIG. 15, each of the first swivel portion 110, the second swivel portion 120, and the third swivel portion 230 may include a drive unit that generates reaction force and a force detection unit that controls magnitude of reaction force, or at least one of the three swivel portions may include a drive unit that generates reaction force and a force detection unit that controls magnitude of the reaction force.

Here, the drive unit that generates reaction force in each of the first to third swivel portions may have the same configuration as one in the input unit 100 illustrated in FIG. 1 described above (the first drive unit 111a or the second drive unit 121a), or may have a different configuration. Further, a force detection unit that controls magnitude of reaction force in each of the first to third swivel portions may have the same configuration as one in the input unit 100 illustrated in FIG. 1 described above (the first force detection unit 111b or the second force detection unit 121b), or may have a different configuration.

### Swivel Stop Mechanism

A configuration of the thumb input unit 200 may include one or more rotation stop mechanisms having the same configuration as the swivel stop mechanism 113 for stopping swivel of a contact portion in the input unit 100 as illustrated in FIG. 15 as still another haptic function, that is, a function for transmitting a feel (hard reaction force) in a case where a robot hand grips a hard object to an operator. In this case, one or more rotation stop mechanisms include at least one of a mechanism for stopping swivel about the first axis of a thumb contact portion, a mechanism for stopping swivel about the second axis of a thumb contact portion, and a mechanism for stopping swivel about the third axis of a thumb contact portion.

Further, a fingertip holding portion may be the thumb holder 202c configured to hold a fingertip of the thumb 2 in a state where the fingertip is fitted, or may be a binding member such as magic tape (registered trademark) for holding the thumb 2.

Furthermore, a configuration of the fingertip holding portion is not limited, and other configurations may be used.

For example, the fingertip holding portion may include a cup-shaped housing into which a fingertip of a finger is fitted and a balloon member provided in the cup-shaped housing, and the balloon member may be configured to be inflated in the cup-shaped housing.

As described above, the thumb input unit 200 of the present invention includes the base portion 101, the thumb contact portion 202 held in a state where the thumb 2 of an operator is in contact, and the detection unit 203 that detects a swivel amount of the thumb contact portion 202 with respect to the base portion 101. Other configurations are not particularly limited as long as the detection unit 203 detects a swivel amount of the thumb contact portion 202 with respect to the base portion 101 according to a bending motion, an extending motion, an adduction motion, and an abduction motion of the thumb 2, and further, a left and right twisting motion of the thumb 2, and simultaneously detects a position of a fingertip of the thumb 2 on the thumb contact portion 202. However, in the second embodiment below, an example of a specific configuration of the finger input unit 200 of the present invention will be described.

### Second Embodiment

FIG. 16 is a schematic diagram for explaining the thumb input unit 200a having a specific configuration as the second embodiment of the input unit of the present invention. FIG. 16(a) is a perspective view, and FIG. 16(b) is a cross-sectional view taken along line A-A of FIG. 16(a).

The thumb input unit 200a detects information for operating a thumb of the robot hand 1200 (see FIG. 18) from a motion of the thumb 2 of an operator. As illustrated in FIG. 16(a), the thumb input unit 200a includes the base portion 101, the thumb contact portion 202 with which the thumb 2 of an operator comes into contact, and the detection unit 203 that detects a swivel amount of the thumb contact portion 202 with respect to the base portion 101. Hereinafter, a configuration of each part will be described in detail, but the above-described three-dimensional coordinates are used in description of a motion of the thumb contact portion 202 and the like.

### Base Portion 101

The reference direction B is set in the base portion 101 as illustrated in FIG. 16(a), and the thumb input unit 200 is configured such that, when an operator attaches the thumb 2 in an extended state to the contact portion 202 of the thumb input unit 200 in order to use the input unit, the reference direction B of the base portion 101 coincides with a width direction of a palm of an operator (that is, a direction in which four fingers other than the thumb are arranged), and a state in which the reference direction B coincides with the width direction of the palm of the operator is maintained during use of the input unit 200, that is, while the thumb 2 is attached to the thumb contact portion 202 in order for use of the input unit 200.

### Thumb Contact Portion 202

As illustrated in FIGS. 12 to 14, the thumb contact portion 202 is supported so as to be able to swivel about three axes with respect to the base portion 201. Note that, in description below, the thumb 2 is assumed to be the thumb of a right hand.

That is, the thumb contact portion 202 is configured to swivel in the first direction D1 about the first axis (about an axis parallel to a width direction of the thumb contact portion 202) with respect to the base portion 101 as illustrated in FIG. 12(a) in accordance with a bending motion of the thumb 2, to swivel in the second direction D2 about the first axis with respect to the base portion 101 in accordance with an extending motion of the thumb 2, to swivel in the fourth direction D4 about the second axis (about an axis parallel to a normal direction of a surface of the thumb contact portion 202) with respect to the base portion 101 as illustrated in FIG. 13(a) in accordance with an adduction motion of the thumb 2, and to swivel in the third direction D3 about the second axis with respect to the base portion 101 in accordance with an abduction motion of the thumb 2.

Further, as illustrated in FIG. 14, the thumb contact portion 202 is configured to swivel in the fifth direction D5 about the third axis (about the longitudinal axis La of the thumb contact portion 202) with respect to the base portion 101 in accordance with a twisting motion of the thumb 2 (motion of twisting a thumb clockwise as viewed from an operator), and to swivel in the sixth direction D6 about the third axis (about the longitudinal axis La of the thumb contact portion 202) with respect to the base portion 101 in accordance with a twisting motion of the thumb 2 in the opposite direction.

Here, the thumb contact portion 202 that holds the thumb 2 has a configuration different from the contact portion 102 in the input unit 100 for a finger other than the thumb 2 of the first embodiment.

Specifically, as illustrated in FIG. 16(a), the thumb contact portion 202 includes the contact portion main body 202a on which a thumb is placed, the fingertip holding portion 202c configured to hold a fingertip of the thumb 2, the movable body 202b attached to be slidable with respect to the contact portion main body 202a, and the connection member 202d connecting the movable body 202b and the fingertip holding portion 202c, and the movable body 202b is configured to move along a direction of the longitudinal axis La in which the contact portion main body 202a extends according to movement of a fingertip held by the fingertip holding portion 202c.

Here, the fingertip holding portion 202c is, for example, a thumb holder configured to hold a fingertip in a state where the fingertip of a finger is fitted. The movable body 202b is a slider slidably attached to the contact portion main body 202a, and the connection member 202d is a two-axis hinge member (universal joint) that connects the movable body 202b and the fingertip holding portion 202c in a manner being able to swivel relatively around two axes orthogonal to each other.

Here, as illustrated in FIG. 16(b), the slider 202b has a linear protrusion 202b1 fitted into a linear recessed portion 202a2 formed in a linear groove 202a1 of the contact portion main body 202a, and the slider 202b is supported slidably in a direction of the longitudinal axis La with respect to the contact portion main body 202a by the linear protrusion 202b1 being engaged with the linear recessed portion 202a2 of the contact portion main body 202a. The connection member 202d may be a ball joint instead of a universal joint.

### Three Swivel Portions

The above-described configuration for supporting the thumb contact portion 202 in a manner being able to swivel about three axes is realized by three of the first to third swivel portions (actuators) 110, 120, and 230 provided between the thumb contact portion 202 and the base portion 201.

Here, each of the first swivel portion (first actuator) 110 and the second swivel portion (second actuator) 120 has the same configuration as that of the input unit 100a described in the first embodiment, and these are coupled by a coupling unit.

The third swivel portion (third actuator) 230 includes a third movable portion 30a that supports the thumb contact portion 202 so as to be able to swivel about the third axis (the longitudinal axis La of the thumb contact portion 202), and a third drive unit 231a that drives the movable portion 30a.

Here, the third axis (the longitudinal axis La of the thumb contact portion 202) is an axis parallel to a palm of an operator and along a direction orthogonal to a width direction of the palm in the initial posture in which the thumb 2 is attached to the thumb contact portion 202 and five fingers are aligned and extended so as to use the thumb input unit 200a. One end (proximal end) of the thumb contact portion 202 is fixed to the movable portion 30a of the third swivel portion 230. The position detection unit 103a is attached to another end (distal end) of the thumb contact portion 202.

### Detection Unit 203

The detection unit 203 is configured to detect a swivel amount about the first axis of the thumb contact portion 202, a swivel amount about the second axis of the thumb contact portion 202, a swivel amount about the third axis of the thumb contact portion 202, and a position of a fingertip of the thumb 2 on the thumb contact portion 202.

That is, the detection unit 203 substantially includes, in addition to the position detection unit 103a, the first swivel amount detection unit 131, and the second swivel amount detection unit 132 in the input unit 100a illustrated in FIG. 8, the third swivel amount detection unit 233 that detects a swivel amount about the third axis of the thumb contact portion 202 (about the longitudinal axis La of the thumb contact portion 202).

In the thumb input unit 200a of the embodiment 2 having such a configuration, it is possible to detect motions of a finger including a twisting motion in addition to bending and extending motions and adduction and abduction motions of the thumb 2 of an operator.

Next, operation of the thumb input unit 200a will be described.

For example, as illustrated in FIG. 12(a), in a case where, in the initial posture in which a swivel axis (the first axis) of the first swivel portion 110 of the thumb input unit 200 is parallel to the X axis, and the longitudinal axis La of the thumb contact portion 202 is parallel to the Y axis, the thumb 2 is bent in the first direction D1 indicated by an arrow in FIG. 12(a), so that the thumb contact portion 202 swivels about the first axis, and the movable body 202b slides with respect to the contact portion main body 202a, the first swivel amount detection unit 131 detects the angle α1 formed by the longitudinal axis La after bending of the thumb contact portion 202 with respect to the longitudinal axis La (axis parallel to the Y axis) in the initial posture, and, the position detection unit 203a detects a position of the thumb 2 on the thumb contact portion 202 as the distance d2 from the position detection unit 203a to the thumb holder 202c. By the above, an angle of each joint of the thumb 2 can be obtained based on inverse kinematics from these detection values. Note that, also in a case where the thumb 2 is extended in the second direction D2 that is the opposite direction to the first direction D1 indicated by an arrow in FIG. 12(a), an angle of each joint of the thumb 2 can be obtained similarly to a case where the thumb 2 is bent in the first direction D1.

Further, in a case where the thumb 2 is the thumb of a right hand, as illustrated in FIG. 13(a), when the thumb 2 is adducted in the initial posture in which the first axis (an axis along a width direction of the thumb contact portion 202) of the thumb input unit 200 is parallel to the X axis and the second axis (the longitudinal axis La of the thumb contact portion 202) is parallel to the Y axis, and the thumb contact portion 202 is rotated about the second axis in the fourth direction D4, the second swivel amount detection unit 132 detects the angle β1 formed by the longitudinal axis La2 after adduction of the thumb contact portion 202 with respect to the Y axis (the longitudinal axis La in the initial posture). By the above, the second swivel amount (swivel amount about the second axis) of the thumb contact portion 202 can be detected. Note that, also in a case where the thumb 2 moves in the third direction D3, which is the opposite direction to the first direction D4 indicated by an arrow in FIG. 13(a) (that is, in a case where the thumb 2 is abducted), the second swivel amount (swivel amount around the second axis) of the thumb contact portion 202 can be detected similarly to the case where the thumb 2 moves in the fourth direction D4.

Further, as illustrated in FIG. 14(a), when the thumb 2 is twisted in the direction D5 indicated by an arrow in the initial posture in which the first axis of the thumb input unit 200 is parallel to the X axis and the third axis is parallel to the Y axis, the thumb contact portion 202 swivels about the longitudinal axis La, and the third swivel amount detection unit 233 detects the angle γ1 formed by the normal line Vd′ after a twisting motion of the thumb contact portion 202 with respect to the Z axis (the normal line Vd of a surface of the thumb contact portion 202 in the initial posture). By the above, the third swivel amount (swivel amount about the third axis) of the thumb contact portion 202 can be detected. Note that also in a case where the thumb 2 is twisted in the sixth direction D6 that is the opposite direction to the fifth direction D5 indicated by an arrow in FIG. 14(a), the third swivel amount (swivel amount around the third axis) of the thumb contact portion 202 can be detected similarly to a case where the thumb 2 is twisted in the fifth direction D5.

As described above, the thumb input unit 200a according to the second embodiment of the present invention includes the base portion 101, the thumb contact portion 202 with which the thumb 2 of an operator is in contact, and the detection unit 203 that detects a swivel amount of the thumb contact portion 202 with respect to the base portion 101, and the detection unit 203 detects a swivel amount of the thumb contact portion with respect to the base portion according to a bending motion, an extending motion, an adduction motion, an abduction motion, and a twisting motion of a finger and simultaneously detects a position of a fingertip of the finger on the thumb contact portion, therefore, it is possible to estimate a posture of a thumb based on inverse kinematics from a swivel amount of the thumb contact portion 202 with respect to the base portion 101 detected by the detection unit 203 and a position of a fingertip of the thumb 2 on the thumb contact portion 202, and as a result, a motion of the thumb 2 of an operator can be detected with high accuracy.

Further, similarly to the first swivel portion 110 and the second swivel portion 120, the third swivel portion 230 is also provided with a configuration for generating reaction force (configuration for realizing a haptic function) described in the input unit 100 of the first embodiment, so that reaction force with respect to operation of the thumb input unit 200 by an operator can be presented in bending and extending motions, adduction and abduction motions, and a twisting motion of the thumb 2, and a feel of a robot hand gripping an object can be presented to the operator.

Note that in the second embodiment, the thumb contact portion 202 having the thumb holder 202c is illustrated as the thumb input unit 200a, however, the thumb holder 202c can preferably not only simply hold an attached thumb but also eliminate variation in adhesion due to a difference in size of fingers of an operator to be attached, and hereinafter, the thumb holder 302c having such a configuration will be described.

FIG. 16A is a schematic diagram for explaining the thumb holder 302c in place of the thumb holder 202c in the thumb input unit 200a illustrated in FIG. 16, FIG. 16A(a) illustrates a state in which the thumb 2 is not attached to the thumb holder 302c, and FIG. 16A(b) illustrates a state in which the thumb 2 is attached to the thumb holder 302c.

The thumb holder 302c illustrated in FIG. 16A copes with variation in adhesion due to a difference in size of fingers of an operator to be attached.

That is, the thumb holder 302c includes a cup-shaped housing 31 into which a fingertip of a thumb is fitted and a balloon member 32 provided in the cup-shaped housing 31, and is configured such that the balloon member 32 is inflated in the cup-shaped housing. Here, the cup-shaped housing 31 is made from metal such as resin or stainless steel, and the balloon member 32 is made from an elastic body such as rubber, but a constituent material is not limited to this.

Here, a contact switch 31a is provided on a bottom surface portion or a side surface portion of the cup-shaped housing 31, one end of an air supply tube 33 that supplies air to the balloon member 32 is connected to the balloon member 32, and another end of the air supply tube 33 is connected to a gas supply source provided in the input unit.

In the thumb holder 302c having the balloon member 32, when the thumb 2 of an operator is fitted into the cup-shaped housing 31 and the thumb of the operator comes into contact with the contact switch 31a, air is supplied from the gas supply source of the input unit to the balloon member 32 via the air supply tube 33, so that the balloon member 32 is inflated.

Alternatively, the thumb holder 302c may inflate the balloon member 32 according to a current position (twisted state) of the thumb contact portion 202 about the third axis. For example, in consideration of a positional relationship between a thumb and a palm, the thumb contact portion 202 always rotates in the D5 direction in FIG. 14 about the third axis (the longitudinal axis La of the thumb contact portion 202) in a use state. For this reason, the thumb contact portion 202 may deflate the balloon member 32 by detecting swivel in the D6 direction opposite to the D5 direction around the third axis, and may inflate by detecting swivel of the thumb contact portion 202 in the D5 direction. Here, a condition for inflating and deflating the balloon is described by exemplifying a swivel range of the thumb contact portion about the third axis, but the condition for inflating and deflating the balloon may be set as a swivel range of the thumb contact portion about another axis.

In the thumb holder 302c having such a configuration, also in a case where size of a thumb of an operator is smaller than size of the cup-shaped housing 31, the thumb can be brought into close contact with the cup-shaped housing 31 by inflation of the balloon member 32.

Further, the input unit 100 and the thumb input unit 200 described above can be individually used as devices for detecting a motion of each of five fingers, but in a case where a robot hand or the like is operated, it is desirable to detect motions of all fingers of a hand by one device.

Therefore, in a situation where an actual robot hand is operated, an input device that detects all motions of five fingers is required. In view of the above, such an input device will be described below.
[3] The input device 10 corresponding to five fingers will be described.

FIG. 17 is a diagram illustrating an input device 10 including the thumb input unit 200 illustrated in FIG. 11 and the input unit 100 illustrated in FIG. 1 corresponding to four fingers other than a thumb.

The input device 10 is an input device for a robot hand, and inputs motion information of five fingers to the robot hand.

Specifically, the input device 10 includes the base portion 101, a palm placement portion 101a, the thumb input unit 200, and four of the input units 100 corresponding to an index finger, a middle finger, a ring finger, and a little finger. On the base portion 101, one of the thumb input unit 200 and four of the input units 100 are arranged along the reference direction B of the base portion 101, and the palm placement portion 101a is fixed on a base portion 1 by a support wall 101b on the rear side of the input units 100 and 200. A palm fixing belt 101c is attached to the palm placement portion 101a. Here, the thumb input unit 200 is illustrated in FIG. 11, and four of the input units 100 are the input unit illustrated in FIG. 1. Note that, needless to say, the configuration of the input unit 100a illustrated in FIG. 8 can be used as a specific configuration of the input unit 100, and the configuration of the thumb input unit 200a illustrated in FIG. 16 can be used as a specific configuration of the thumb input unit 200.

In the input device 10, when the thumb 2 of a hand of an operator is attached to the thumb holder 202c of the thumb input unit 200, and the index finger, the middle finger, the ring finger, and the little finger of the hand of the operator are disposed on the contact portions 102 of four of the input units 100, motions of all the fingers can be detected.

In the input device 10, when an operator moves a finger other than a thumb, a posture of the moved finger (an angle of each joint) is detected based on a swivel amount of the contact portion 102 in the input unit 100 corresponding to the moved finger and a position of the finger in the contact portion 102. Further, when an operator moves a thumb, a posture of the thumb is detected from a swivel amount of the contact portion 202 in the thumb input unit 200 and a position of the finger on the contact portion 202 (a position of the movable body 202b).

Therefore, the input device 10 can be used as a device that detects a motion of each finger in a system that drives a finger of a robot hand based on a motion of each finger of an operator, and a system including the input device 10 will be described below.

This system is a robot operation system, and includes at least one of the input unit 100 illustrated in FIG. 1 and one of the thumb input unit 200 illustrated in FIG. 12. Furthermore, the robot operation system includes an information processing device configured to estimate a posture of a finger of an operator based on a swivel amount of a contact portion detected by the input unit and a position of a fingertip on the contact portion, and a robot configured to be operated based on the estimated posture of the finger of the operator. Here, a swivel amount of a contact portion detected by the input unit includes a swivel amount about the first axis of the contact portion and a swivel amount about the second axis of the contact portion. Further, a swivel amount of a contact portion detected by a thumb input unit includes a swivel amount about the third axis of a connection portion in addition to a swivel amount about the first axis of the contact portion and a swivel amount about the second axis of the contact portion.
[4] Hereinafter, this robot operation system will be specifically described.

FIG. 18 is a conceptual diagram illustrating a robot operation system 1000 for causing the robot 1200 to perform a motion of a finger as a system including the input device 10 illustrated in FIG. 17.

The system 1000 includes the input device 10 that detects a motion of fingers (five fingers) of an operator, a computer device 1100, and the robot 1200.

In the system 1000, the input device 10 detects information on a motion of a finger of an operator, and the computer device 1100 generates a control signal for moving the robot 1200 based on the information detected by the input device 10 and outputs the control signal to the robot 1200. The robot 1200 performs operation of reproducing the motion of the finger of the operator according to the control signal output from the computer device 1100.

Note that the computer device 1100 may be, for example, a dedicated computer device or a general-purpose computer device. The computer device 1100 may be, for example, a computer device of a desktop type, a laptop type, a tablet type, a smartphone type, or the like. The computer device 1100 may be connected to the input device 10 and/or the robot 1200 in a wired manner or in a wireless manner, for example. For example, the input device 10 and the computer device 1100 may be connected via a network (for example, the Internet, a LAN, or the like). Furthermore, the computer device 1100 may be implemented as, for example, a computer device separate from the input device 10, or may be mounted in the input device 10.

In the example illustrated in FIG. 18, the computer device 1100 is illustrated as a laptop type computer device.

Here, in a case where a motion part of an operator is a finger, one having a part corresponding to the finger of the operator is shown as the robot 1200, however, a part of the robot 1200 corresponding to a motion part of an operator does not necessarily have the same shape and structure (for example, length, thickness, number of joints, degree of freedom of joints, and the like of the part) as the motion part of the operator, and may be different from a shape and structure of the motion part of the operator as long as the robot 1200 can perform a desired motion. In a case where a part of the robot 1200 has the same shape and structure as a corresponding part of an operator, the robot 1200 can accurately reproduce a motion of the operator. On the other hand, in a case where a part of the robot 1200 has a minimum shape and structure for realizing a desired motion, a calculation amount for determining a motion of the robot 1200 can be reduced to prevent delay in reaction of the robot 1200.

Further, the input device 10 may be used in a system that detects a motion of an upper limb of an operator, and such a system will be described below.
[5] A system 2000 for motion information on an upper limb will be described.

This system is a system for detecting a motion of an upper limb of an operator, and includes at least one input unit illustrated in FIG. 1 and an upper limb motion input device for inputting a motion of an upper limb of an operator. Here, the upper limb motion input device includes a first joint connected to the input unit, a second joint fixedly disposed at a place different from a body of an operator, and a third joint connecting a first arm extending from the first joint and a second arm extending from the second joint.

Hereinafter, the system 2000 that detects a motion of an upper limb will be specifically described.

FIG. 19 is a schematic diagram illustrating the system 2000 for inputting a motion of an upper limb of an operator as a system including the input device 10 illustrated in FIG. 17.

The system 2000 includes an upper limb motion input device 20 for inputting a motion of an upper limb of an operator and the input device 10 described above.

In the system 2000, the upper limb motion input device 20 includes a first joint 2100 connected to the base portion 101 of the input device 10, a second joint 2200 fixedly disposed at a place (base body) 2001 different from a body of an operator, and a third joint 2300 connecting a first arm 2010 extending from the first joint 2100 and a second arm 2020 extending from the second joint 2200. In the system 2000, a hand Uh of an operator is fixed to the input device 10.

Then, in the system 2000, when an operator Us moves the hand Uh to which the input device 10 is fixed, a posture of the first arm 2010 with respect to the base portion 101 of the input device 10 changes in the first joint 2100, a posture of the second arm 2020 with respect to the base body 2001 changes in the second joint 2200, and a posture of the second arm 2020 with respect to the first arm 2010 changes in the third joint 2300.

Therefore, in the system 2000, the upper limb motion input device 20 detects a posture change (that is, a posture change of one member with respect to another member) between the members joined by each joint, so that information on a motion of an upper limb can be obtained.

Further, in the system 2000, when an operator moves a finger of a hand fixed to the input device 10, the input device 10 detects a motion of the finger of the operator, and information on a motion of the finger is obtained.

As described above, in the system 2000 including the input device 10 and the upper limb motion input device 20, when an operator moves a hand (arm), the upper limb motion input device 20 detects a motion of an upper limb of the operator, and when the operator moves a finger, the input device 10 detects a motion of the finger of the operator. As a result, the system 2000 can output information on the motion of the upper limb of the operator as well as the motion of the finger of the operator to a robot to cause the robot to reproduce the motion of the upper limb as well as the motion of the finger, and can cause the robot to perform a motion closer to a motion of a human body.

Note that, here, as information indicating a motion of an upper limb, one obtained from a posture change between members joined by each joint is shown, but information indicating a motion of an upper limb is not limited to this, and may be, for example, a value obtained by integrating force applied to the entire input device 10. In this case, the upper limb motion input device 20 includes a six-axis force sensor that detects force applied to the input device 10 and a calculating means that integrates force applied to the input device 10 detected by the force sensor. The force sensor is provided, for example, at a bottom portion of the input device 10. Further, the upper limb motion input device 20 is configured to output a value obtained by integrating force applied to the input device 10 detected by the force sensor as information indicating a motion of an upper limb.

As described above, the present invention is exemplified using the preferred embodiment of the present invention, but the present invention should not be construed as being limited to the embodiment. It is understood that the scope of the present invention is to be interpreted only by the claims. It is understood that a person skilled in the art can implement an equivalent range based on description of the present invention and the common general knowledge from description of a specific preferred embodiment of the present invention. It is understood that the document cited herein is to be incorporated by reference herein in the same manner as its content is specifically described herein.

The present disclosure has several applications. The present invention is useful to obtain an input unit capable of detecting not only bending and extending motions of a finger of an operator but also motion of a finger including adduction and abduction motions, and an input device using a plurality of such input units corresponding to five fingers.

Further, the present invention is useful to obtain a system for performing robot operation using the input device of the present invention, and a system including the input device of the present invention as a system for detecting a motion of an upper limb of an operator.

### DESCRIPTION OF REFERENCE LABELS

1 finger (index finger)
2 thumb
10 input device
50 swivel portion (actuator)
51 base block
52a first slide block
52b second slide block
53a first motor
53b second motor
54a first ball screw
54b second ball screw
55 universal joint
56 support body
100 input unit
101 base portion
101a palm placement portion
101b support wall
101c palm fixing belt
102 contact portion
102a linear groove
103 detection unit
103a position detection unit
131 first swivel amount detection unit
132 second swivel amount detection unit
110, 1101, 1102 first swivel portion (first actuator)
10a, 10a1, 10a2 first movable portion
10b housing-side fixing portion
11a rotation shaft portion
11b shaft-side fixing portion
111a first drive unit
111b first force detection unit
111c first displacement amount detection unit
112 elastic member
112a first elastic member
112b second elastic member
112c compression spring
112d spring ball plunger
112e torsion spring
113 rotation stop mechanism
113a rigid rotation member
13a movable main body portion
13b locking piece
113b rigid stationary member
13c stationary main body portion
13d abutment piece
120 second swivel portion (second actuator)
20a second movable portion
121a second drive unit
121b second force detection unit
200 thumb input unit
202 contact portion
202a contact portion main body
202b movable body (slider)
202c thumb holder
202d connection member
203 detection unit
233 third swivel amount detection unit
230 third swivel portion (third actuator)
30a third movable portion
231a third drive unit
231b third force detection unit
1000, 2000 system
1100 computer device
1200 robot hand
2001 base body
2010 first arm
2020 second arm
2100 first joint
2200 second joint
2300 third joint
D1 first direction
D2 second direction
D3 third direction
D4 fourth direction
D5 fifth direction
D6 sixth direction

What is claimed is:

1. An input unit for robot operation, the input unit comprising:
a base portion;
a contact portion provided to be able to swivel with respect to the base portion and in contact with a finger of an operator; and
a detection unit that detects a swivel amount of the contact portion with respect to the base portion, wherein
the contact portion is configured to:
swivel in a first direction about a first axis with respect to the base portion according to a bending motion of the finger;
swivel in a second direction about the first axis with respect to the base portion according to an extending motion of the finger;
swivel in a third direction about a second axis with respect to the base portion according to an adduction motion of the finger; and
swivel in a fourth direction about the second axis with respect to the base portion according to an abduction motion of the finger, and
the detection unit is configured to detect a swivel amount about the first axis of the contact portion, a swivel amount about the second axis of the contact portion, and a position of a fingertip of the finger on the contact portion.

2. The input unit according to claim 1, further comprising a drive unit that generates reaction force for swiveling the contact portion about the axis.

3. The input unit according to claim 2, wherein
the drive unit is a second drive unit that generates second reaction force that swivels the contact portion about the second axis.

4. The input unit according to claim 3, further comprising a second force detection unit for detecting the second reaction force, wherein
the second drive unit is controlled based on the second reaction force detected by the second force detection unit; and/or the second force detection unit includes a strain gauge.

5. (canceled)

6. The input unit according to claim 4, wherein
the second force detection unit includes an elastic body connected to the second drive unit and the contact portion.

7. The input unit according to claim 2, further comprising an elastic body connected to the drive unit and the contact portion, wherein
the elastic body is disposed about the axis so as to extend or contract according to the drive unit driving the contact portion to swivel in one direction about the axis; and/or the elastic body includes a first elastic member and a second elastic member, and
the first elastic member and the second elastic member are disposed about the axis such that the first elastic member extends and the second elastic member contracts according to the drive unit driving the contact portion to swivel in one direction about the axis.

8. (canceled)

9. The input unit according to claim 1, further comprising a swivel stop mechanism that stops swivel of the contact portion.

10. The input unit according to claim 9, wherein
the swivel stop mechanism includes:
a rigid rotation member configured to be rotated about the axis by the drive unit; and
a rigid stationary member configured to prevent rotation by an angle equal to or more than a threshold of the rigid rotation member, and
the rigid stationary member collides with the rigid rotation member to stop rotation of the contact portion when rotation by an angle equal to or more than the threshold of the rigid rotation member occurs.

11. The input unit according to claim 2, wherein
the drive unit is configured to generate both first reaction force for swiveling the contact portion about the first axis and second reaction force for swiveling the contact portion about the second axis.

12. The input unit according to claim 1, wherein
the contact portion includes:
a contact portion main body;
a fingertip holding portion configured to hold a fingertip of the finger; and
a movable body coupled to the fingertip holding portion, and
the movable body is configured to be movable along an extending direction of the contact portion main body in accordance with movement of the fingertip held by the fingertip holding portion.

13. The input unit according to claim 12, wherein
the detection unit detects a position of the fingertip by detecting a position of the movable body; and/or the fingertip holding portion is configured to hold a fingertip of the finger in a state where the fingertip is fitted.

14. (canceled)

15. The input unit according to claim 12, wherein
the fingertip holding portion includes a cup-shaped housing into which a fingertip of the finger is fitted and a balloon member provided in the cup-shaped housing, and the balloon member is configured to be inflated in the cup-shaped housing.

16. The input unit according to claim 12, wherein
the fingertip holding portion and the movable body are coupled by a universal joint.

17. The input unit according to claim 12, wherein
the contact portion is configured to further swivel about a third axis with respect to the base portion, and
the third axis is an axis along a direction in which the contact portion main body extends.

18. The input unit of claim 12, wherein
the finger is a thumb.

19. An input device for robot operation, the input device comprising:
five of the input units according to claim 1;
wherein the contact portion of one of the five input units, includes:
a contact portion main body;
a fingertip holding portion configured to hold a fingertip of the finger; and
a movable body coupled to the fingertip holding portion, and
wherein the movable body is configured to be movable along an extending direction of the contact portion main body in accordance with movement of the fingertip held by the fingertip holding portion.

20. A robot operation system, comprising:
the input unit according to claim 1;
an information processing device configured to estimate a posture of a finger of the operator based on a swivel amount of the contact portion detected by the input unit and a position of the fingertip on the contact portion; and
a robot configured to be operated based on the estimated posture of the finger of the operator, wherein
the swivel amount of the contact portion detected by the input unit includes:
a swivel amount about the first axis of the contact portion; and
a swivel amount about the second axis of the contact portion.

21. A system for inputting a motion of an upper limb of an operator, the system comprising:
the input unit according to claim 1; and
an arm motion input device for inputting a motion of an arm of the operator.

22. The system according to claim 21, wherein
the arm motion input device includes:
a first joint connected to the input unit;
a second joint fixedly disposed at a place different from a body of the operator; and
a third joint connecting a first arm extending from the first joint and a second arm extending from the second joint, and
a posture change of the first arm with respect to the input unit, a posture change of the second arm with respect to the first arm, and a posture change of the second joint with respect to the place are output as information indicating a motion of the upper limb.

23. The system according to claim 21, wherein
the arm motion input device includes:
a force sensor that detects force applied to the input device; and
calculating means for integrating force applied to the input device, the force being detected by the force sensor, and
an integral value of force applied to the input device is output as information indicating a motion of the upper limb.
